(19) United States
(12) Patent Application Publication
(10) Pub. No.: US 2009/0138266 A1
(43) Pub. Date: May 28, 2009

(54) APPARATUS, METHOD, AND COMPUTER PROGRAM PRODUCT FOR RECOGNIZING SPEECH

(75) Inventor: Hisayoshi NAGAE, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/201,195

(22) Filed: Aug. 29, 2008

(30) Foreign Application Priority Data
Nov. 26, 2007 (JP) 2007-304171

(51) Int. Cl. G10L 15/04

(52) U.S. Cl. 704/254; 704/E15.001

(57) ABSTRACT

A contiguous word recognizing unit recognizes speech as a morpheme string, based on an acoustic model and a language model. A sentence obtaining unit obtains an exemplary sentence related to the speech out of a correct sentence storage unit. Based on the degree of matching, a sentence correspondence bringing unit brings first morphemes contained in the recognized morpheme string into correspondence with second morphemes contained in the obtained exemplary sentence. A disparity detecting unit detects one or more of the first morphemes each of which does not match the corresponding one of the second morphemes as disparity portions. A cause information obtaining unit obtains output information that corresponds to a condition satisfied by each of the disparity portions out of a cause information storage unit. An output unit outputs the obtained output information.

### CROSS-REFERENCE TO RELATED APPLICATIONS

This application is based upon and claims the benefit of priority from the prior Japanese Patent Application No. 2007-304171, filed on Nov. 26, 2007; the entire contents of which are incorporated herein by reference.

### BACKGROUND OF THE INVENTION

1. Field of the Invention

The present invention relates to an apparatus, a method, and a computer program product for recognizing speech and determining problems related to a manner in which a user uttered the speech or an input sentence, when the speech is erroneously recognized.

2. Description of the Related Art

In recent years, speech recognition systems to which the user is able to input sentences using speech have been put to practical use and have started being used in various fields as practical systems. However, so far there has been no system that is supported by users and that has resulted in very good sales. One of the reasons is that the speech recognition systems sometimes erroneously recognize the input speech. Although the level of the recognition performance is improving year by year due to the advancement of technology, there has been no speech recognition system having a level of performance that is high enough to correctly recognize all ways of speaking by all users.

To cope with this situation, various methods have been developed so as to improve the level of performance of speech recognition systems. For example, JP-A 2003-280683 (KOKAI) has proposed a technique for improving the level of recognition performance by changing the recognition vocabulary that is to be processed in the speech recognition process, depending on the field to which each input sentence belongs, so that a higher priority is given to appropriate vocabulary and appropriate homonyms according to each input sentence.

In addition, in the speech recognition systems that are currently available, it is sometimes possible to avoid erroneous recognition by improving the method of use. For example, generally speaking, when a user utters speech to be input to a speech recognition system, it is desirable that the user “speaks fluently with a constant rhythm, slowly, carefully, and plainly”. Also, as for the sentences to be input to the speech recognition system, it is desirable that “many of the words and expressions in the sentences are grammatically correct and commonly used”. The percentage of correct recognition among users who have mastered such a method of use is greatly different from the percentage of correct recognition among users who haven't.

Further, because different users have different speech characteristics, what type of erroneous recognition is incurred by what type of speech will greatly vary depending on the user. In addition, depending on the tendencies of the data stored in the databases used by the speech recognition system, the tendencies in the erroneous recognition will also greatly vary. Thus, there is no method of use that is applicable to all users and is able to completely avoid erroneous recognition.

Furthermore, during a speech recognition process, speech uttered by a user, which is an analogue signal, is input to the speech recognition system. Thus, even if the same user is using the speech recognition system, the speech input to the system may vary depending on the time, the place, and the circumstances. Accordingly, the tendencies in erroneous recognition may also vary. Ultimately, efficient use of speech recognition systems can be mastered only when the user has learned the tendencies and traits of the machine from experience. For example, the user needs to learn, through trial and error, information as to how he/she should speak in order to be recognized correctly, what is the optimal distance between the microphone and the user's mouth, and what words and expressions are more likely to bring about a desired result.

However, conventional methods like the one disclosed in JP-A 2003-280683 (KOKAI) focus on realizing a speech recognition process with a high level of precision mainly by improving the processes performed within the speech recognition system. Thus, even if the processes performed within the system are improved, there is still a possibility that the level of precision in the speech recognition process may be lowered by the processes performed on the outside of the system such as an inappropriate method of use employed by the user.

### SUMMARY OF THE INVENTION

According to one aspect of the present invention, a speech recognition apparatus includes an exemplary sentence storage unit that stores exemplary sentences; an information storage unit that stores conditions and pieces of output information that are brought into correspondence with one another, each of the conditions being defined in advance based on a disparity portion and contents of a disparity between inputs of speech and any of the exemplary sentences, and each of the pieces of output information being related to a cause of the corresponding disparity; an input unit that receives an input of speech; a first recognizing unit that recognizes the input speech as a morpheme string, based on an acoustic model defining acoustic characteristics of phonemes and a language model defining connection relationships among morphemes; a sentence obtaining unit that obtains one of the exemplary sentences related to the input speech from the exemplary sentence storage unit; a sentence correspondence bringing unit that brings each of first morphemes into correspondence with at least one of second morphemes, based on a degree of matching to which each of the first morphemes contained in the recognized morpheme string matches any of the second morphemes contained in the obtained exemplary sentence; a disparity detecting unit that detects one or more of the first morphemes each of which does not match the corresponding one of the second morphemes, as the disparity portions; an information obtaining unit that obtains one of the pieces of output information corresponding to the condition of each of the detected disparity portions, from the information storage unit; and an output unit that outputs the obtained pieces of output information.

According to another aspect of the present invention, a speech recognition method includes receiving an input of speech; recognizing the input speech as a morpheme string, based on an acoustic model defining acoustic characteristics of phonemes and a language model defining connection relationships among morphemes; obtaining, from an exemplary sentence storage unit storing exemplary sentences, one of the exemplary sentences that is related to the input speech; bringing, based on a degree of matching to which each of first morphemes contained in the recognized morpheme string matches any of second morphemes contained in the obtained exemplary sentence, each of the first morphemes into correspondence with at least one of the second morphemes; detecting one or more of the first morphemes each of which does not match the corresponding one of the second morphemes as disparity portions; obtaining, from an information storage unit storing conditions each being defined in advance based on a disparity portion and contents of a disparity and pieces of output information each being related to a cause of a disparity while bringing the conditions and the pieces of output information into correspondence with one another, one of the pieces of output information corresponding to the condition of each of the detected disparity portions; and outputting the obtained pieces of output information.

A computer program product according to still another aspect of the present invention causes a computer to perform the method according to the present invention.

### BRIEF DESCRIPTION OF THE DRAWINGS

FIG. 1 is a block diagram of a speech recognition apparatus according to a first embodiment of the present invention;

FIG. 2 is a diagram illustrating an example of a data structure of a correct sentence stored in a correct sentence storage unit;

FIG. 3 is a diagram illustrating an example of a data structure of cause information stored in a cause information storage unit;

FIG. 4 is a diagram illustrating an example of a data structure of a morpheme string generated by a contiguous word recognizing unit;

FIG. 5 is a flowchart of an overall procedure in a speech recognition process according to the first embodiment;

FIG. 6 is a flowchart of an overall procedure in a disparity detecting process according to the first embodiment;

FIG. 7 is a diagram illustrating an example of morphemes that have been brought into correspondence by a sentence correspondence bringing unit;

FIG. 8 is a diagram illustrating an example of a display screen on which pieces of advice are displayed;

FIG. 9 is a block diagram of a speech recognition apparatus according to a second embodiment of the present invention;

FIG. 10 is a diagram illustrating an example of a data structure of a sample sentence stored in a sample sentence storage unit;

FIG. 11 is a flowchart of an overall procedure in a speech recognition process according to the second embodiment;

FIG. 12 is a flowchart of an overall procedure in a disparity detecting process according to the second embodiment;

FIG. 13 is a diagram illustrating an example of morphemes that have been brought into correspondence by the sentence correspondence bringing unit;

FIG. 14 is a diagram illustrating an example of a display screen on which a piece of advice is displayed;

FIG. 15 is a block diagram of a speech recognition apparatus according to a third embodiment of the present invention;

FIG. 16 is a diagram illustrating an example of a data structure of a monosyllable string that has been generated;

FIG. 17 is a flowchart of an overall procedure in a speech recognition process according to the third embodiment;

FIG. 18 is a flowchart of an overall procedure in a disparity detecting process according to the third embodiment;

FIG. 19 is a diagram illustrating an example of morphemes that have been brought into correspondence by the sentence correspondence bringing unit;

FIG. 20 is a diagram illustrating an example of a result of a correspondence bringing process performed by a syllable correspondence bringing unit;

FIG. 21 is a diagram illustrating an example in which results of correspondence bringing processes are combined;

FIG. 22 is a diagram illustrating an example of a display screen on which pieces of advice are displayed;

FIG. 23 is a block diagram of a speech recognition apparatus according to a fourth embodiment of the present invention;

FIG. 24 is a diagram illustrating an example of a data structure of acoustic information;

FIG. 25 is a diagram illustrating an example of a data structure of cause information stored in a cause information storage unit;

FIG. 26 is a flowchart of an overall procedure in a speech recognition process according to the fourth embodiment;

FIG. 27 is a diagram illustrating an example of a data structure of a sample sentence stored in a sample sentence storage unit;

FIG. 28 is a diagram illustrating an example of a data structure of a morpheme string that has been generated by the contiguous word recognizing unit;

FIG. 29 is a diagram illustrating an example of morphemes that have been brought into correspondence by the sentence correspondence bringing unit;

FIG. 30 is a diagram illustrating an example of a result of a correspondence bringing process performed by an acoustic correspondence bringing unit;

FIG. 31 is a diagram illustrating an example in which results of correspondence bringing processes are combined;

FIG. 32 is a diagram illustrating an example of a display screen on which pieces of advice are displayed; and

FIG. 33 is a diagram illustrating a hardware configuration of the speech recognition apparatuses according to the first to the fourth embodiments.

### DETAILED DESCRIPTION OF THE INVENTION

Exemplary embodiments of an apparatus, a method, and a computer program product according to the present invention will be explained in detail, with reference to the accompanying drawings.

A speech recognition apparatus according to a first embodiment of the present invention compares a correct sentence that is one of exemplary sentences registered in advance with a result of a speech recognition process performed on an input of speech that has been input by a user uttering the correct sentence, detects one or more disparity portions, determines the causes of the disparities such as improper utterances, the user's traits, or unnatural parts in the input sentence, and outputs how to utter the speech correctly and how to select a sentence to be input, as advice to the user.

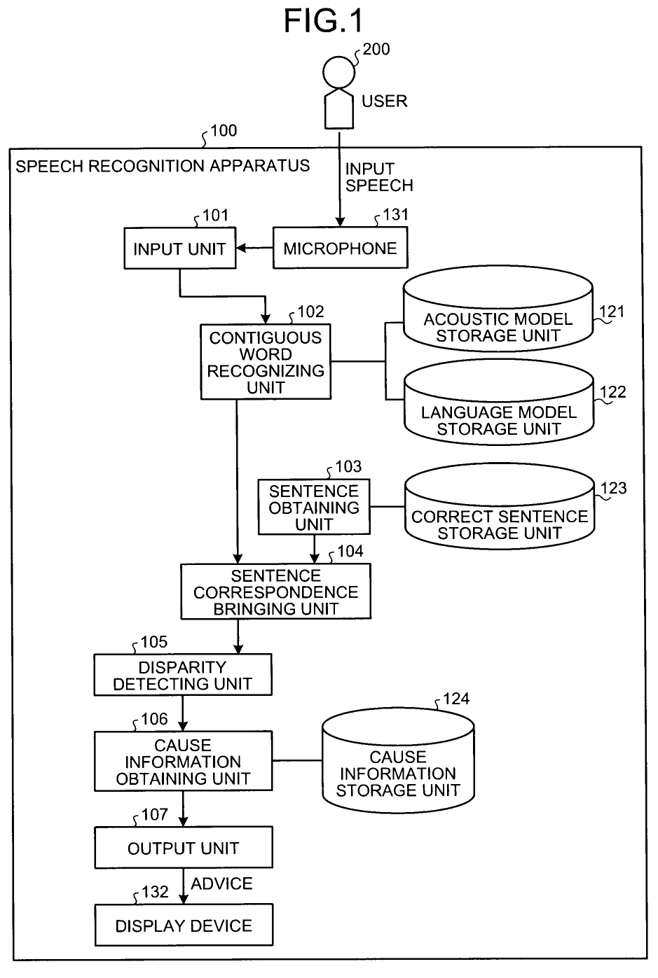

As shown in FIG. 1, a speech recognition apparatus 100 includes, as the principal hardware configuration thereof, a microphone 131, a display device 132, an acoustic model storage unit 121, a language model storage unit 122, a correct sentence storage unit 123, and a cause information storage unit 124. Also, the speech recognition apparatus 100 includes, as the principal software configuration thereof, an input unit 101, a contiguous word recognizing unit 102, a sentence obtaining unit 103, a sentence correspondence bringing unit 104, a disparity detecting unit 105, a cause information obtaining unit 106, and an output unit 107.

The microphone 131 receives an input of speech uttered by a user. The display device 132 displays various types of screens and messages that are necessary for performing a speech recognition process.

The acoustic model storage unit 121 stores therein an acoustic model in which acoustic characteristics of phonemes are defined. More specifically, the acoustic model storage unit 121 stores therein a standard pattern of the characteristic amount of each of the phonemes. For example, the acoustic model storage unit 121 stores therein an acoustic model expressed by using the Hidden Markov Model (HMM).

The language model storage unit 122 stores therein a language model in which connection relationships among morphemes are defined in advance. For example, the language model storage unit 122 stores therein a language model expressed by using the N-gram Model.

The correct sentence storage unit 123 stores therein correct sentences each of which is defined, in advance, as an exemplary sentence for the speech to be input. According to the first embodiment, for example, the user specifies a correct sentence out of a number of correct sentences displayed on the display device 132 and inputs speech to the speech recognition apparatus 100 by uttering the specified correct sentence.

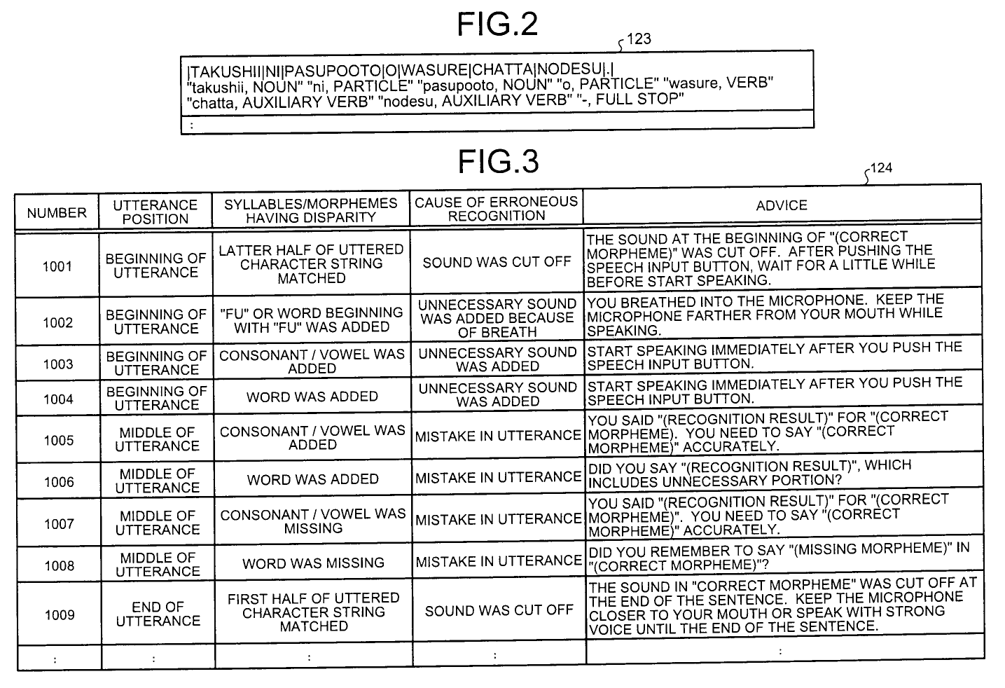

As shown in FIG. 2, the correct sentence storage unit 123 stores therein correct sentences each of which is divided into morphemes by using a symbol “|”. Also, the correct sentence storage unit 123 stores therein, for each of the morphemes, a piece of morpheme information that is a set made up of the reading of the morpheme and the part of speech (e.g., noun, verb, etc.) of the morpheme, while keeping the morphemes and the pieces of morpheme information in correspondence with one another. In FIG. 2, an example is shown in which pieces of morpheme information are stored in an order that corresponds to the order in which the morphemes are arranged, while each of the pieces of morpheme information is expressed by using the format of “(the reading of the morpheme), (the part of speech)”.

Returning to the description of FIG. 1, the cause information storage unit 124 stores therein pieces of cause information in each of which (i) a condition that is defined in advance for one of different patterns of disparity portions that can be found between input speech and selected correct sentences, (ii) a cause of the disparity, and (iii) a piece of advice to be output for the user are kept in correspondence with one another.

As shown in FIG. 3, the cause information storage unit 124 stores therein the pieces of cause information in each of which a number that identifies the piece of cause information, an utterance position, syllables/morphemes having a disparity, the cause of erroneous recognition, and a piece of advice are kept in correspondence with one another.

The “UTTERANCE POSITION” denotes a condition (i.e., a position condition) related to the position of the disparity portion with respect to the entire input speech. In the examples shown in FIG. 3, “BEGINNING OF UTTERANCE”, which denotes a position at the beginning of an utterance, “MIDDLE OF UTTERANCE” which denotes any position other than the beginning and the end of an utterance (hereinafter, “(the) middle of (an) utterance”), and “END OF UTTERANCE” which denotes a position at the end of an utterance are specified. The method for specifying the utterance positions is not limited to these examples. It is acceptable to use any other method as long as it is possible to identify each of the disparity portions with respect to the entire input speech.

The “SYLLABLES/MORPHEMES HAVING DISPARITY” denotes a condition (i.e., vocabulary condition) related to vocabulary (i.e., syllables and/or morphemes) having a disparity that is found between a morpheme string obtained as a result of the recognition process performed on the input speech and a morpheme string in a corresponding correct sentence. For example, in the case where a result of the recognition process has a disparity because one or more consonants and/or vowels are added thereto, the corresponding condition is “CONSONANT/VOWEL WAS ADDED”, which is identified with the number 1003.

The cause information storage unit 124 stores therein information that shows, in the form of a database, causes of erroneous recognitions in different situations of disparities that are expected to be found between the results of the speech recognition process and the correct sentences. For example, in the case where a beginning portion of an utterance is missing from a result of the speech recognition process, we can presume that the cause is that the user's speech in the beginning portion was not input to the speech recognition system. Thus, “SOUND WAS CUT OFF” identified with the number 1001 in the drawing is specified as the cause of the erroneous recognition. As another example, in the case where one or more unnecessary syllables such as “fu” or “fufu” are added to the beginning portion of an utterance, we can presume that the cause is that one or more unnecessary syllables were input because the user breathed into the microphone 131. Thus, “UNNECESSARY SOUND WAS ADDED BECAUSE OF BREATH” identified with the number 1002 in the drawing is specified as the cause of the erroneous recognition.

The cause information storage unit 124 is referred to by the cause information obtaining unit 106 when searching for a condition that is satisfied by a disparity portion that has been detected by the disparity detecting unit 105 and obtaining a piece of cause information that corresponds to the disparity portion.

The acoustic model storage unit 121, the language model storage unit 122, the correct sentence storage unit 123, and the cause information storage unit 124 may be configured with one or more storage media of any kind that are commonly used, such as Hard Disk Drives (HDDs), optical disks, memory cards, and Random Access Memories (RAMs).

Returning to the description of FIG. 1, the input unit 101 performs a sampling process on an analog signal of the input speech that has been input through the microphone 131, converts the analog signal into a digital signal that is, for example, in a pulse code modulation (PCM) format, and outputs the digital signal. The process performed by the input unit 101 may be realized by using an analog-to-digital (A/D) conversion technique that has conventionally been used. It is acceptable to configure the input unit 101 so that the input unit 101 receives an input of speech from the microphone 131 in response to a predetermined operation such as, for example, an operation to push a speech input button (not shown). Also, another arrangement is acceptable in which the analog signal of the user's speech is separately digitalized in advance, so that, when the system is in use, the input unit 101 receives the input of speech by receiving the digital data that is directly input thereto. In that situation, it is not necessary to provide the microphone or the A/D converter.

The contiguous word recognizing unit 102 recognizes the input speech by using the acoustic model and the language model and generates a morpheme string as a result of the recognition process.

More specifically, first, the contiguous word recognizing unit 102 calculates the characteristic amount of the audio signal in the utterance by analyzing, for example, temporal changes in the frequency with the use of a Fast Fourier Transform (FFT) analysis method. After that, the contiguous word recognizing unit 102 compares the acoustic model stored in the acoustic model storage unit 121 and the characteristic amount calculated in the process described above and generates recognition candidates for the input speech.

Further, the contiguous word recognizing unit 102 recognizes the speech with a high level of precision by selecting, based on an assumption, the most probable candidate out of the generated recognition candidates by using the language model. The speech recognition process performed by the contiguous word recognizing unit 102 that uses the acoustic model and the language model may be realized by using a speech dictation technique that has conventionally been used.

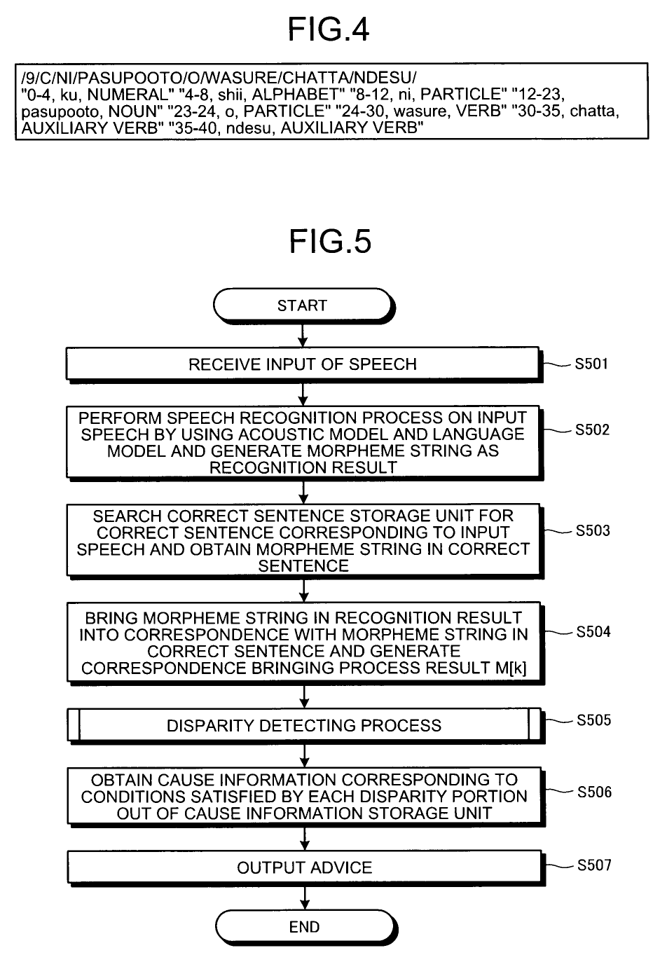

As shown in FIG. 4, the contiguous word recognizing unit 102 generates a morpheme string in which the recognized morphemes are separated from one another by the symbol “/”. Each of the morphemes is brought into correspondence with a piece of morpheme information that is a set made up of a speech section, the reading of the morpheme, and the part of speech (e.g., noun, verb, etc.) of the morpheme. The speech section indicates a period of time from the utterance starting time to the utterance ending time that is expressed while the beginning of the input speech is used as a point of reference. In FIG. 4, an example is shown in which the pieces of morpheme information are generated in an order that corresponds to the order in which the morphemes are arranged, while each of the pieces of morpheme information is in the format of “(speech section), (reading of the morpheme), (the part of speech)”.

The sentence obtaining unit 103 obtains, out of the correct sentence storage unit 123, the correct sentence that has been specified by the user, as the exemplary sentence for the input speech at the input source. The sentence obtaining unit 103 also obtains the pieces of morpheme information that have been brought into correspondence with the correct sentence, out of the correct sentence storage unit 123. To allow the user to specify one of the correct sentences, it is acceptable to use any method that has conventionally been used, such as prompting the user to select one out of a list of correct sentences being displayed by using a button (not shown) or the like.

The sentence correspondence bringing unit 104 brings the morpheme string in the obtained correct sentence into correspondence with the morpheme string in the result of the recognition process. More specifically, the sentence correspondence bringing unit 104 calculates the degree of matching that expresses the degree to which the morphemes included in the morpheme string in the result of the recognition process match the morphemes included in the morpheme string in the correct sentence so that the morphemes are brought into correspondence with one another in such a manner that makes the degree of matching of the entire sentence the largest. The process performed by the sentence correspondence bringing unit 104 may be realized by using, for example, a dynamic programming (DP) matching method.

The disparity detecting unit 105 compares each of the morphemes in the result of the recognition process with the one of the morphemes in the correct sentence that has been brought into correspondence, detects one or more disparity portions each of which contains at least one morpheme that does not match the corresponding morpheme in the correct sentence, and outputs time information of each of the detected disparity portions. The time information is information that indicates the speech section of each of the disparity portions within the input speech. More specifically, for each of the disparity portions, the time information includes the starting time of the first morpheme in the disparity portion and the ending time of the last morpheme in the disparity portion.

The cause information obtaining unit 106 analyzes each of the detected disparity portions and obtains one of the pieces of cause information related to the cause of the disparity, out of the cause information storage unit 124. More specifically, the cause information obtaining unit 106 determines the utterance position of each of the disparity portions within the input speech and obtains one or more syllables or morphemes that does not match the corresponding morpheme in the correct sentence. After that, the cause information obtaining unit 106 searches the cause information storage unit 124 for a piece of cause information in which the determined utterance position satisfies the position condition (i.e., the utterance position stored in the cause information storage unit 124), and also, in which the obtained syllables or morphemes satisfies the vocabulary condition (i.e., the syllables/morphemes having a disparity stored in the cause information storage unit 124). Further, for each of the disparity portions, the cause information obtaining unit 106 obtains the cause of erroneous recognition included in the obtained piece of cause information as the cause of the disparity and obtains the piece of advice included in the obtained piece of cause information as output information to be output for the user.

In the case where the cause information obtaining unit 106 has failed to find the cause information that matches the conditions in the cause information storage unit 124 during the searching process, the cause information obtaining unit 106 obtains general advice as the output information. For example, in that situation, the cause information obtaining unit 106 obtains a piece of advice that is prepared in advance such as “RECOGNITION PROCESS FAILED. SPEAK A LITTLE MORE SLOWLY AND CAREFULLY.” as the output information.

The output unit 107 controls a process to output various types of information to the display device 132 and the like. For example, the output unit 107 outputs the result of the recognition process that has been generated and the output information that has been obtained to the display device 132. Another arrangement is acceptable in which the output unit 107 includes an audio synthesizing unit (not shown) that synthesizes text information into an audio signal so that the output unit 107 outputs the audio of the output information synthesized by the audio synthesizing unit to a speaker (not shown) or the like.

Next, the speech recognition process performed by the speech recognition apparatus 100 according to the first embodiment configured as described above will be explained, with reference to FIG. 5.

First, the input unit 101 receives an input of speech that has been uttered by a user (step S501). For example, the user specifies, in advance, a correct sentence that he/she is going to utter, out of the correct sentences stored in the correct sentence storage unit 123 and inputs the input speech by reading the specified correct sentence. Another arrangement is acceptable in which the user reads one of the correct sentences that has arbitrarily been specified by the speech recognition apparatus 100.

Next, the contiguous word recognizing unit 102 performs a speech recognition process on the input speech by using the acoustic model and the language model and generates a morpheme string as a result of the recognition process (step S502).

After that, the sentence obtaining unit 103 obtains, out of the correct sentence storage unit 123, one of the correct sentences that has been specified by the user as the correct sentence corresponding to the input speech, as well as the morpheme string of the correct sentence (step S503).

Subsequently, by using the DP matching method or the like, the sentence correspondence bringing unit 104 brings the morphemes in the morpheme string in the result of the recognition process into correspondence with the morphemes in the morpheme string in the correct sentence and generates results M[k] of the correspondence bringing process (k: 1 to N, where N is the total number of sets of morphemes that have been brought into correspondence with each other) (step S504). The results M[k] of the correspondence bringing process include the morpheme string M[k].R in the result of the recognition process and the morpheme string M[k].E in the correct sentence.

After that, by using the correspondence results M[k], the disparity detecting unit 105 performs the disparity detecting process so as to detect one or more disparity portions in each of which the corresponding morpheme strings do not match (step S505). The details of the disparity detecting process will be explained later.

Subsequently, the cause information obtaining unit 106 obtains one of the pieces of cause information that corresponds to the conditions satisfied by each of the detected disparity portions, out of the cause information storage unit 124 (step S506). After that, the output unit 107 outputs the piece of advice included in the obtained piece of cause information to the display device 132 (step S507), and the speech recognition process ends.

By performing the process described above, it is possible to determine the cause of the disparity (i.e., the cause of the erroneous recognition) in each of the disparity portions that have been found between the input speech and the correct sentence and to present a piece of advice that can be used to avoid the erroneous recognition, to the user. In other words, by outputting the information with which the user is able to improve the method of use, it is possible to aim to improve the level of precision in the recognition process performed in the future.

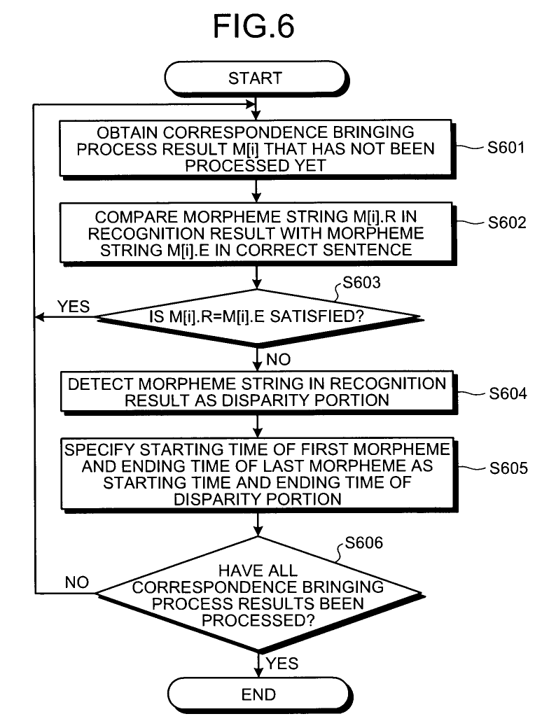

Next, the details of the disparity detection process at step S505 will be explained, with reference to FIG. 6.

First, the disparity detecting unit 105 obtains a result M[i] (where 1≦i≦N) of the correspondence bringing process that has not been processed yet, out of the results of the correspondence bringing process that have been generated by the sentence correspondence bringing unit 104 (step S601). After that, the disparity detecting unit 105 compares the morpheme string M[i].R in the result of the recognition process with the morpheme string M[i].E in the correct sentence, the morpheme string M[i].R and M[i].E being contained in M[i] (step S602).

Subsequently, the disparity detecting unit judges whether M[i].R=M[i].E is satisfied, i.e., whether they match (step S603). In the case where the disparity detecting unit 105 has judged that they match (step S603: Yes), the disparity detecting unit 105 obtains a next unprocessed result of the correspondence bringing process and repeats the processes described above (step S601).

In the case where the disparity detecting unit 105 has judged that they do not match (step S603: No), the disparity detecting unit 105 detects the morpheme string M[i].R in the result of the recognition process that has been brought into correspondence as a disparity portion (step S604). Also, the disparity detecting unit 105 specifies the starting time of the first morpheme and the ending time of the last morpheme in the morpheme string M[i].R in the result of the recognition process as the starting time and the ending time of the disparity portion, respectively (step S605).

After that, the disparity detecting unit 105 judges whether all the results of the correspondence bringing process have been processed (step S606). In the case where the disparity detecting unit 105 has judged that not all the results have been processed (step S606: No), the disparity detecting unit 105 obtains a next unprocessed result of the correspondence bringing process and repeats the processes described above (step S601). In the case where the disparity detecting unit 105 has judged that all the results have been processed (step S606: Yes), the disparity detecting unit 105 ends the disparity detecting process.

Next, a specific example of the speech recognition process according to the first embodiment will be explained. In the following sections, an example in which a correct sentence in Japanese “Takushii ni pasupooto o wasure chatta nodesu” shown in FIG. 2, which means “I left my passport in a taxi”, has been specified and corresponding input speech has been input will be explained.

The contiguous word recognizing unit 102 recognizes the input speech and generates a morpheme string as a result of the recognition process (step S502). In the present example, it is assumed that a morpheme string as shown in FIG. 4 has been generated.

The sentence obtaining unit 103 obtains the correct sentence as shown in FIG. 2 and the morpheme string that corresponds to the correct sentence, out of the correct sentence storage unit 123 (step S503).

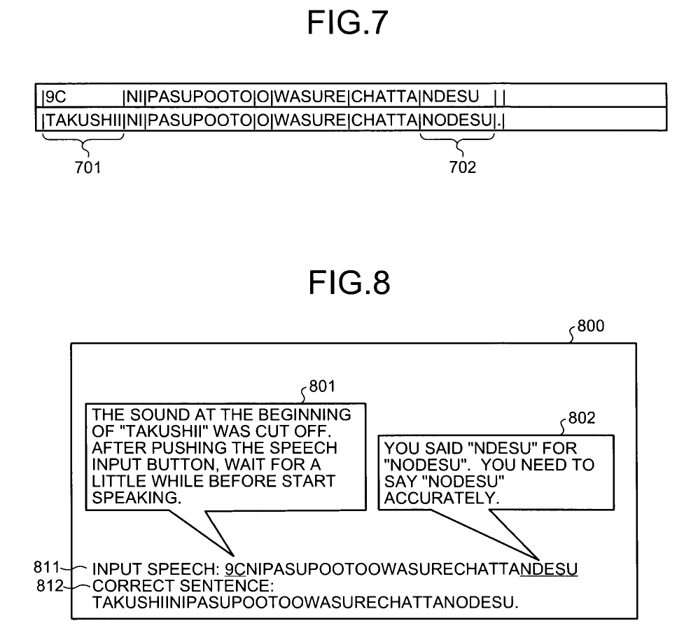

When the result of the recognition process as shown in FIG. 4 and the correct sentence as shown in FIG. 2 have been obtained, the sentence correspondence bringing unit 104 brings the morphemes into correspondence with one another by determining the degree of matching between the two morpheme strings (step S504). In FIG. 7, the symbol “|” indicates the start and the end of each of the morphemes that have been brought into correspondence. The morpheme string in the result of the recognition process as shown in FIG. 4 is shown at the top of FIG. 7, whereas the correct sentence as shown in FIG. 2 is shown at the bottom of FIG. 7.

The disparity detecting unit 105 compares the morphemes that have been brought into correspondence as shown in FIG. 7 with each other and detects one or more disparity portions (step S505). In the example shown in FIG. 7, the disparity detecting unit 105 detects a disparity portion 701 positioned at the beginning of the utterance and a disparity portion 702 positioned in the middle of the utterance.

After that, the cause information obtaining unit 106 analyzes the utterance position of each of the disparity portions within the input speech and the contents of the disparity. For example, the cause information obtaining unit 106 determines that the utterance position of the disparity portion 701 is at the beginning of the utterance. Also, with regard to the disparity portion 701, the cause information obtaining unit 106 determines that the reading of the morpheme string “9C” in the result of the recognition process is “kushii” and that it partially matches the latter half (i.e., “kushii”) of the reading (i.e., “takushii”) of the morpheme “TAKUSHII” in the correct sentence. (Note: One of the pronunciations of the numeral “9” is “ku” in Japanese; the alphabet letter “C” can be read as “shii” in Japanese.)

As another example, the cause information obtaining unit 106 also determines that the utterance position of the disparity portion 702 is in the middle of the utterance. Also, with regard to the disparity portion 702, the cause information obtaining unit 106 determines that the reading of the morpheme “NDESU” in the result of the recognition process is “ndesu” and that it is different from the reading “nodesu” of the morpheme “NODESU” in the correct sentence because “no” is changed to “n”.

After that, the cause information obtaining unit 106 searches the cause information storage unit 124 for a piece of cause information that corresponds to the conditions that are satisfied by the determined utterance position and the contents of each of the disparities (step S506). In the case where the cause information storage unit 124 stores therein the pieces of cause information as shown in FIG. 3, the cause information obtaining unit 106 obtains the piece of cause information identified with the number 1001 for the disparity portion 701, because the utterance position of the disparity portion 701 is the “BEGINNING OF UTTERANCE”, and also the reading of the latter half thereof partially matches the reading of the corresponding morpheme in the correct sentence.

Also, the cause information obtaining unit 106 obtains the piece of cause information identified with the number 1007 for the disparity portion 702, because the utterance position of the disparity portion 702 is the “MIDDLE OF UTTERANCE”, and the change from “no” to “n” corresponds to the disparity identified as “VOWEL IS MISSING”.

As a result, the cause information obtaining unit 106 has obtained the pieces of advice identified with the numbers 1001 and 1007, for the disparity portions 701 and 702, respectively. Subsequently, the output unit 107 outputs the obtained pieces of advice to the display device 132 (step S507).

As shown in FIG. 8, on a display screen 800, an input speech 811 and a corresponding correct sentence 812 are displayed. In addition, the obtained pieces of advice 801 and 802 are also displayed. In FIG. 8, an example in which the piece of advice 801 for the disparity portion 701 and the piece of advice 802 for the disparity portion 702 are displayed is shown.

The output unit 107 displays, on the display screen, the piece of advice identified with the number 1001 in FIG. 3 while the corresponding morpheme in the correct sentence is embedded in the portion indicated as “(CORRECT MORPHEME)” in FIG. 3. Also, the output unit 107 displays, on the display screen, the piece of advice identified with the number 1007 in FIG. 3 while the corresponding morpheme in the result of the recognition process is embedded in the portion indicated as “(RECOGNITION RESULT)” in FIG. 3.

Another arrangement is acceptable in which the output unit 107 outputs the causes of erroneous recognition, together with the pieces of advice or instead of the pieces of advice. Yet another arrangement is acceptable in which the output unit 107 outputs the pieces of advice in the form of audio.

As explained above, the speech recognition apparatus according to the first embodiment detects one or more disparity portions by comparing the correct sentence with the result obtained by performing the recognition process on the input speech, determines the causes of the disparities by referring to the database that stores therein the causes of erroneous recognition that have been specified in advance, and displays the determined causes and the determined methods for avoiding the erroneous recognition, together with the result of the recognition process being displayed.

As a result, the user is able to learn about improper utterances and traits in his/her own utterances. In addition, the user is able to obtain specific advice information regarding his/her own utterances immediately after he/she inputs his/her speech. Thus, the user is able to easily learn how to utter speech correctly and how to select a sentence to be input so that his/her speech will be correctly recognized in the future. Further, the user is able to efficiently learn the tendencies and the traits of erroneous recognition made by the speech recognition apparatus. Accordingly, the user is able to master the efficient use of the speech recognition apparatus in a shorter period of time. The user's improving his/her method of use for the speech recognition apparatus will eventually lead to an improvement in the level of precision of the speech recognition process.

In a speech recognition apparatus according to a second embodiment of the present invention, instead of the correct sentences, sample sentences that have been registered in advance as exemplary sentences for the speech to be input are used. The second embodiment is configured so as to be suitable for an example-based search method in which the speech recognition process is used as a front end. In other words, the speech recognition apparatus according to the second embodiment searches a storage unit for a sample sentence that completely matches, or is similar to, a result of the recognition process performed on the input speech and uses the sample sentence found in the search as a result of the recognition process. It is also possible to apply the speech recognition apparatus according to the second embodiment to a speech recognition function in an example-based translating apparatus that further includes a translating unit that translates the obtained sample sentence.

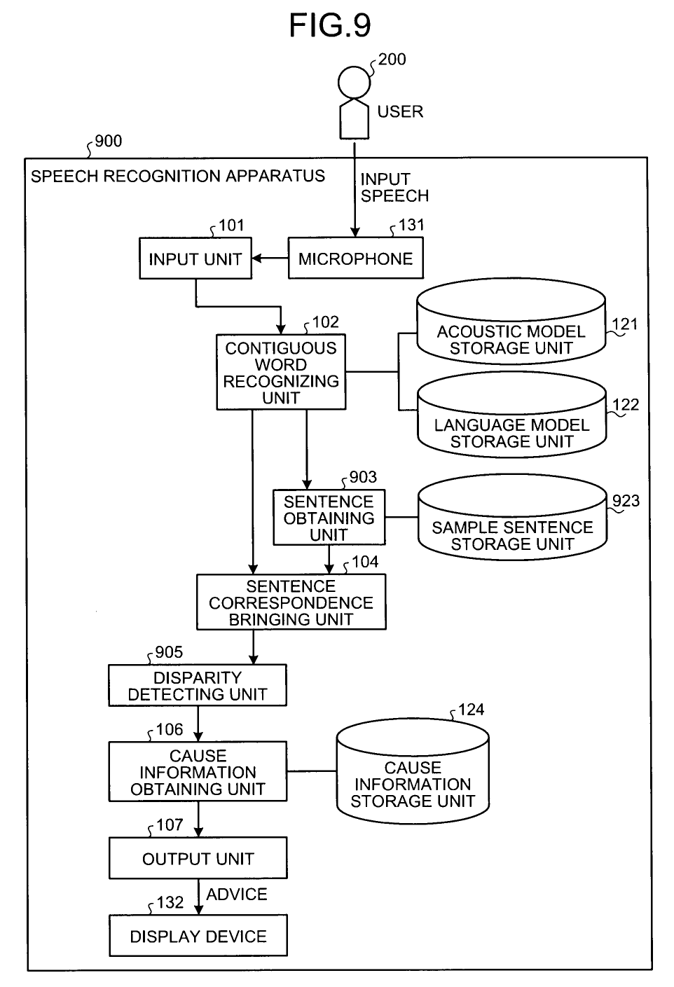

As shown in FIG. 9, a speech recognition apparatus 900 includes, as the principal hardware configuration thereof, the microphone 131, the display device 132, the acoustic model storage unit 121, the language model storage unit 122, a sample sentence storage unit 923, and the cause information storage unit 124. Also, the speech recognition apparatus 900 includes, as the principal software configuration thereof, the input unit 101, the contiguous word recognizing unit 102, a sentence obtaining unit 903, the sentence correspondence bringing unit 104, a disparity detecting unit 905, the cause information obtaining unit 106, and the output unit 107.

The second embodiment is different from the first embodiment in that the speech recognition apparatus 900 includes the sample sentence storage unit 923 instead of the correct sentence storage unit 123 and that the sentence obtaining unit 903 and the disparity detecting unit 905 have functions that are different from those of the first embodiment. The other configurations and functions are the same as those shown in FIG. 1, which is a block diagram of the speech recognition apparatus 100 according to the first embodiment. Thus, the same configurations and functions will be referred to by using the same reference characters, and the explanation thereof will be omitted.

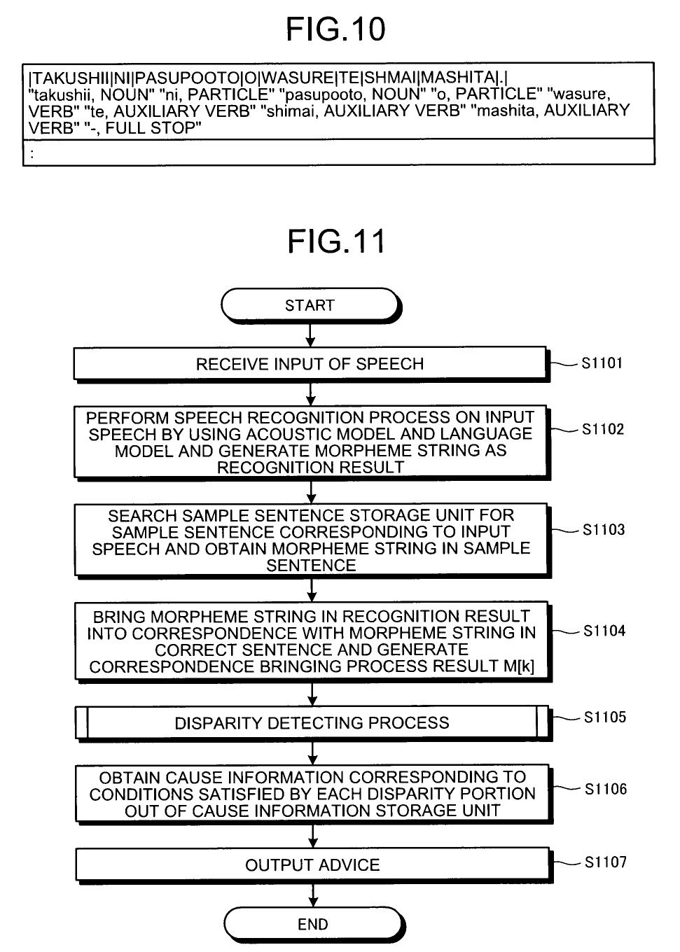

The sample sentence storage unit 923 stores therein sample sentences each of which serves as an exemplary sentence for the speech to be input. FIG. 10 is a diagram illustrating an example of a data structure of a sample sentence stored in the sample sentence storage unit 923. Like the correct sentence storage unit 123 shown in FIG. 2, the sample sentence storage unit 923 stores therein sample sentences each of which is divided into morphemes by using the symbol “|”. Also, the sample sentence storage unit 923 stores therein, for each of the morphemes, a piece of morpheme information that is a set made up of the reading of the morpheme and the part of speech (e.g., noun, verb, etc.) of the morpheme, while keeping the morphemes and the pieces of morpheme information in correspondence with one another.

The sentence obtaining unit 903 obtains, out of the sample sentence storage unit 923, one of the sample sentences that completely matches, or is similar to, the result of the recognition process performed on the input speech. The result of the recognition process and the sample sentence do not necessarily have to include morpheme strings that are completely the same as each other. In other words, to obtain a corresponding sample sentence, the sentence obtaining unit 903 searches for a sentence that has the same meaning even if some of the nouns or the numerals in the sentence and the expression at the end of the sentence may be slightly different from the result of the recognition process. Such a searching method for the sample sentence may be realized by using, for example, the method described in Makoto NAGAO (editor), “Iwanami Kouza Software Kagaku Vol. 15, Shizen Gengo Shori”, 12.8 Jitsurei-gata Kikai Honyaku Houshiki (pp. 502-510), ISBN 4-00-010355-5.

The disparity detecting unit 905 compares each of the morphemes in the result of the recognition process with the one of the morphemes in the sample sentence that has been brought into correspondence, detects one or more disparity portions each of which contains at least one morpheme that does not match the corresponding morpheme in the sample sentence, and outputs time information of each of the detected disparity portions.

When a search is conducted for a sample sentence, there is a possibility that a sample sentence found in the search may be similar, as the whole sentence, to the result of the recognition process but may contain one or more morphemes that do not at all match the corresponding morphemes. In the case where the character strings in the morphemes are completely different from each other, such portions should not be detected as an erroneous recognition portions. Thus, the disparity detecting unit 905 according to the second embodiment does not detect any portions of the sentence as a disparity portion unless a predetermined number or more of the characters included in the character string within each of the morphemes in the result of the recognition process match the characters included in the character string within the corresponding morpheme in the sample sentence. For example, the disparity portion detecting unit 905 may be configured so that, if the ratio of the number of non-matching characters to the total number of characters in the morpheme is equal to or higher than a predetermined threshold value (e.g., 80%), the disparity portion detecting unit 905 does not detect the morpheme as a disparity portion.

Next, the speech recognition process performed by the speech recognition apparatus 900 according to the second embodiment configured as described above will be explained, with reference to FIG. 11.

The speech inputting process and the morpheme string generating process performed at steps S1101 through S1102 are the same as the processes at steps S501 through S502 performed by the speech recognition apparatus 100 according to the first embodiment. Thus, the explanation thereof will be omitted.

After that, the sentence obtaining unit 903 searches the sample sentence storage unit 923 for a sample sentence that completely matches, or is similar to, the morpheme string in the result of the recognition process performed on the input speech, as well as pieces of morpheme information of the sample sentence (step S1103).

The process at step S1104 is the same as the process at step S504 performed by the speech recognition apparatus 100 according to the first embodiment, except that, at step S1104, the morpheme string in the sample sentence is used instead of the morpheme string in the correct sentence.

After that, the disparity detecting unit 905 performs a disparity detecting process (step S1105). The details of the disparity detecting process will be explained later.

The cause information obtaining process and the outputting process performed at steps S1106 through S1107 are the same as the processes at steps S506 through S507 performed by the speech recognition apparatus 100 according to the first embodiment. Thus, the explanation thereof will be omitted.

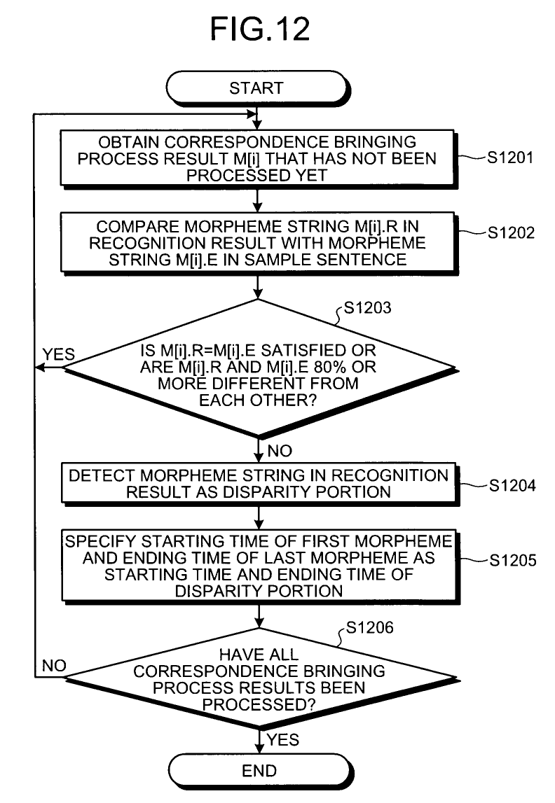

Next, the details of the disparity detecting process performed at step S1105 will be explained, with reference to FIG. 12. According to the second embodiment, the process performed at step S1203 is different from the process performed at step S503 shown in FIG. 6, which is a diagram illustrating the disparity detecting process according to the first embodiment. Because the processes at the other steps are the same as those according to the first embodiment, the explanation thereof will be omitted.

At step S1203, in addition to the process to judge whether M[i].R=M[i].E is satisfied, i.e., whether they match, the disparity detecting unit 905 also performs a process to compare the character string contained in M[i].R with the character string contained in M[i].E. More specifically, the disparity detecting unit 905 counts the number of non-matching characters within the character string contained in M[i].R and the character string contained in M[i].E. Further, the disparity detecting unit 905 calculates the ratio of the number of non-matching characters to the total number of characters. After that, the disparity detecting unit 905 judges whether the calculated ratio is equal to or higher than 80%, which is the predetermined threshold value.

In the case where either M[i].R=M[i].E is satisfied or the character string contained in M[i].R and the character string contained in M[i].E are 80% or more different from each other (step S1203: Yes), the disparity detecting unit 905 does not detect M[i].R as a disparity portion. In any other cases (step S1203: No), the disparity detecting unit 905 detects M[i].R as a disparity portion (step S1204).

Next, a specific example of the speech recognition process according to the second embodiment will be explained. In the following sections, an example in which input speech in Japanese “Takushii ni pasupooto o wasure chatta nodesu” meaning “I left my passport in a taxi” has been input will be explained.

The contiguous word recognizing unit 102 recognizes the input speech and generates a morpheme string as a result of the recognition process (step S1102). In the present example, it is assumed that a morpheme string as shown in FIG. 4 has been generated. It is also assumed that, as a sample sentence that is similar to the morpheme string shown in FIG. 4, the sentence obtaining unit 903 has obtained a sample sentence as shown in FIG. 10, out of the sample sentence storage unit 923 (step S1103).

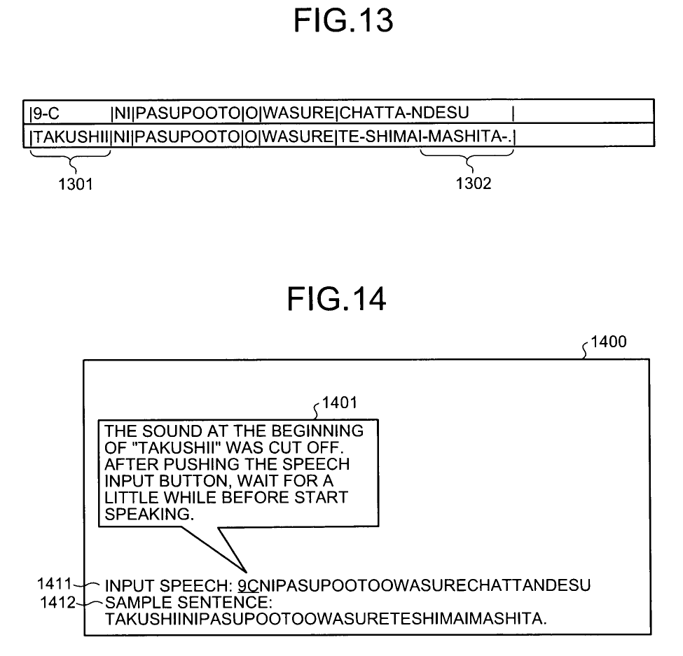

When the result of the recognition process as shown in FIG. 4 and the sample sentence as shown in FIG. 10 have been obtained, the sentence correspondence bringing unit 104 brings the morphemes into correspondence with one another by determining the degree of matching between the two morpheme strings (step S1104). FIG. 13 is a diagram illustrating an example of the morphemes that have been brought into correspondence with one another by the sentence correspondence bringing unit 104. The morpheme string in the result of the recognition process as shown in FIG. 4 is shown at the top of FIG. 13, whereas the sample sentence as shown in FIG. 10 is shown at the bottom of FIG. 13.

In the example shown in FIG. 13, the sentence correspondence bringing unit 104 uses a symbol “-” to divide any one of the morphemes that has no corresponding morpheme. Also, in the case where a character string does not match its corresponding character string for a predetermined length or longer, the sentence correspondence bringing unit 104 collectively brings a section into correspondence with a section. In FIG. 13, the section identified with the reference character 1302 has collectively been brought into correspondence in such a manner.

The disparity detecting unit 905 compares the morphemes that have been brought into correspondence as shown in FIG. 13 with each other and detects one or more disparity portions (step S1105). In the example shown in FIG. 13, the disparity detecting unit 905 detects a disparity portion 1301 at the beginning of the utterance. In the section 1302, because the ratio of the non-matching characters is higher than 80%, the disparity detecting unit 905 does not detect the section 1302 as a disparity portion (step S1203: Yes).

After that, the cause information obtaining unit 106 analyzes the utterance position of the disparity portion within the input speech and the contents of the disparity. The cause information obtaining unit 106 then searches the cause information storage unit 124 for a piece of cause information that corresponds to the conditions satisfied by the analyzed utterance position and the contents of the disparity (step S1106). In the example shown in FIG. 13, the cause information obtaining unit 106 obtains the piece of cause information identified with a number 1001 in FIG. 3.

As a result, the cause information obtaining unit 106 has obtained the piece of advice identified with the number 1001 for the disparity portion 1301. Subsequently, the output unit 107 outputs the obtained piece of advice to the display device 132 (step S1107).

As shown in FIG. 14, on a display screen 1400, a input speech 1411 and a sample sentence 1412 that has been found in the search are displayed. In addition, the obtained piece of advice 1401 is also displayed.

As explained above, even if the speech recognition process based on the example-based search method is applied, the speech recognition apparatus according to the second embodiment is able to achieve the similar advantageous effect as that of the first embodiment.

As explained earlier, it is also possible to apply the method according to the second embodiment to an example-based translating apparatus that translates input speech by using parallel translation samples. There is a possibility that the owner of such an example-based translating apparatus may take the apparatus on a trip and ask local people who are not familiar with the operation of the apparatus and the method of utterance to speak into the apparatus. The method according to the second embodiment is able to cope with such a situation and to output advice as to how to improve the method of use. Thus, the speech recognition apparatus enables the user to communicate smoothly.

A speech recognition apparatus according to a third embodiment of the present invention further recognizes input speech in units of syllables and compares the result of the recognition process with a result of a recognition process performed in units of morphemes. Thus, the speech recognition apparatus according to the third embodiment is able to detect disparity portions with a higher level of precision.

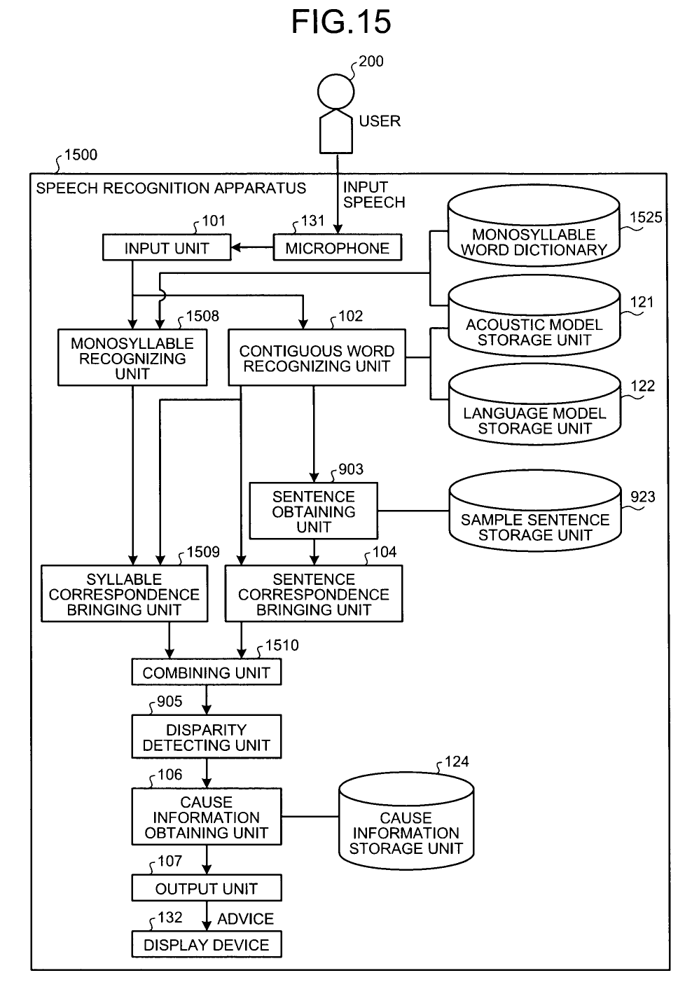

As shown in FIG. 15, a speech recognition apparatus 1500 includes, as the principal hardware configuration thereof, the microphone 131, the display device 132, the acoustic model storage unit 121, the language model storage unit 122, the sample sentence storage unit 923, the cause information storage unit 124, and a monosyllable word dictionary 1525. Also, the speech recognition apparatus 1500 includes, as the principal software configuration thereof, the input unit 101, the contiguous word recognizing unit 102, the sentence obtaining unit 903, the sentence correspondence bringing unit 104, a disparity detecting unit 1505, the cause information obtaining unit 106, the output unit 107, a monosyllable recognizing unit 1508, a syllable correspondence bringing unit 1509, and a combining unit 1510.

The third embodiment is different from the second embodiment in that the monosyllable word dictionary, the monosyllable recognizing unit 1508, the syllable correspondence bringing unit 1509, and the combining unit 1510 are additionally provided and that the disparity detecting unit 1505 has a function that is different from that of the second embodiment. The other configurations and functions are the same as those shown in FIG. 9, which is a block diagram of the speech recognition apparatus 900 according to the second embodiment. Thus, the same configurations and functions will be referred to by using the same reference characters, and the explanation thereof will be omitted.

The monosyllable word dictionary 1525 stores therein a word dictionary that is referred to by the monosyllable recognizing unit 1508 when recognizing speech in units of monosyllables.

The monosyllable recognizing unit 1508 recognizes the input speech by using the acoustic model and the word dictionary and generates a monosyllable string as a result of the recognition process. The monosyllable recognizing unit 1508 recognizes the input speech in units of monosyllables each of which is a vowel or a set made up of a consonant and a vowel that, in Japanese, corresponds to a phonogram such as one Hiragana character (e.g., a Japanese alphabet corresponding to the sound of “a”, “i”, “u”, “ka”, “sa”, “ta”, or the like). The monosyllable recognizing unit 1508 then outputs the monosyllable string as a result of the recognition process.

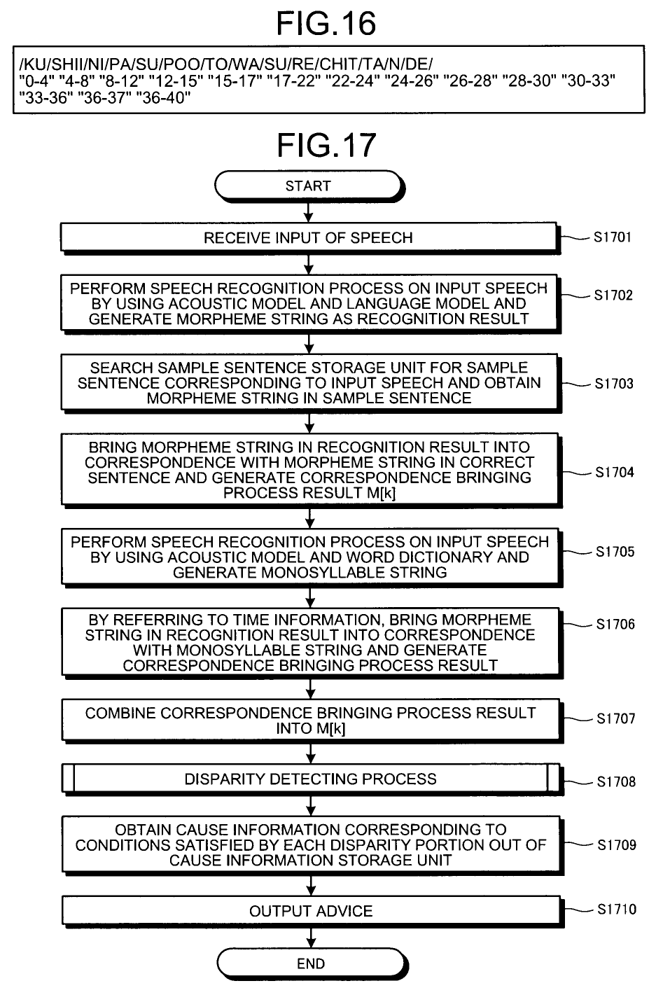

As shown in FIG. 16, the monosyllable recognizing unit 1508 generates the monosyllable string in which the recognized monosyllables are separated from one another by a symbol “/”. Also, each of the monosyllables is brought into correspondence with a speech section indicating a period of time from the utterance starting time to the utterance ending time and being expressed while the beginning of the input speech is used as a point of reference.

The syllable correspondence bringing unit 1509 brings the monosyllable string obtained as the result of the recognition process performed by the monosyllable recognizing unit 1508 into correspondence with the morpheme string obtained as the result of the recognition process performed by the contiguous word recognizing unit 102. More specifically, the syllable correspondence bringing unit 1509 refers to the starting time and the ending time of each of the monosyllables and the starting time and the ending time of each of the morphemes and brings the syllables whose times match into correspondence with each other, the starting times and the ending times each being expressed while the beginning of the input speech is used as a point of reference.

The combining unit 1510 combines the result of the correspondence bringing process performed by the sentence correspondence bringing unit 104 and the result of the correspondence bringing process performed by the syllable correspondence bringing unit 1509. The combining unit 1510 thus brings the monosyllable string, the morpheme string in the result of the recognition process, and the morpheme string in the sample sentence into correspondence with one another.

The disparity detecting unit 1505 detects one or more disparity portions by comparing the monosyllable string, the morpheme strings in the result of the recognition process, and the sample sentence that have been brought into correspondence and outputs time information of the detected disparity portions. When the recognition process is performed in units of monosyllables, it is possible to accurately recognize the input speech in units of sounds, based on only the information in the speech uttered by the user. Thus, the disparity detecting unit 1505 is able to detect the disparity portions with a high level of precision by comparing the result of the recognition process performed in units of morphemes with the result of the recognition process performed in units of monosyllables. In other words, according to the third embodiment, it is possible to more accurately understand how the user utters the speech.

Next, the speech recognition process performed by the speech recognition apparatus 1500 according to the third embodiment configured as described above will be explained, with reference to FIG. 17.

The speech inputting process, the morpheme string generating process, the sample sentence searching process, and the sentence correspondence bringing process performed at steps S1701 through S1704 are the same as the processes at steps S1101 through S1104 performed by the speech recognition apparatus 900 according to the second embodiment. Thus, the explanation thereof will be omitted.

After that, the monosyllable recognizing unit 1508 performs a speech recognition process on the input speech by using the acoustic model and the word dictionary and generates a monosyllable string (step S1705). Subsequently, by referring to the time information, the syllable correspondence bringing unit 1509 brings the morpheme string in the result of the recognition process into correspondence with the monosyllable string in the result of the recognition process and generates a result of the correspondence bringing process (step S1706).

After that, the combining unit 1510 combines the result of the correspondence bringing process performed by the syllable correspondence bringing unit 1509 into the results M[k] obtained as a result of the correspondence bringing process performed by the sentence correspondence bringing unit 104 (step S1707). Because each of the results of the correspondence bringing processes includes the morpheme string serving as the result of the recognition process, the combining unit 1510 is able to combine the two results of the correspondence bringing processes by using the morpheme strings as references.

The order in which the processes at steps S1703 through S1704 and the processes at steps S1705 through 1706 are performed is not limited to the example described above. It is acceptable to perform the processes at steps S1705 through S1706 first. Another arrangement is acceptable in which the processes at steps S1703 through S1704 and the processes at steps S1705 through 1706 are performed in parallel. In other words, it is acceptable to perform these processes in any order as long as the results of the correspondence bringing processes have been generated by the time when the combining unit 1510 is to combine these results of the correspondence bringing processes together.

After that, the disparity detecting unit 1505 performs a disparity detecting process (step S1708). The details of the disparity detecting process will be explained later.

The cause information obtaining process and the outputting process performed at steps S1709 through S1710 are the same as the processes at steps S1106 through S1107 performed by the speech recognition apparatus 900 according to the second embodiment. Thus, the explanation thereof will be omitted.

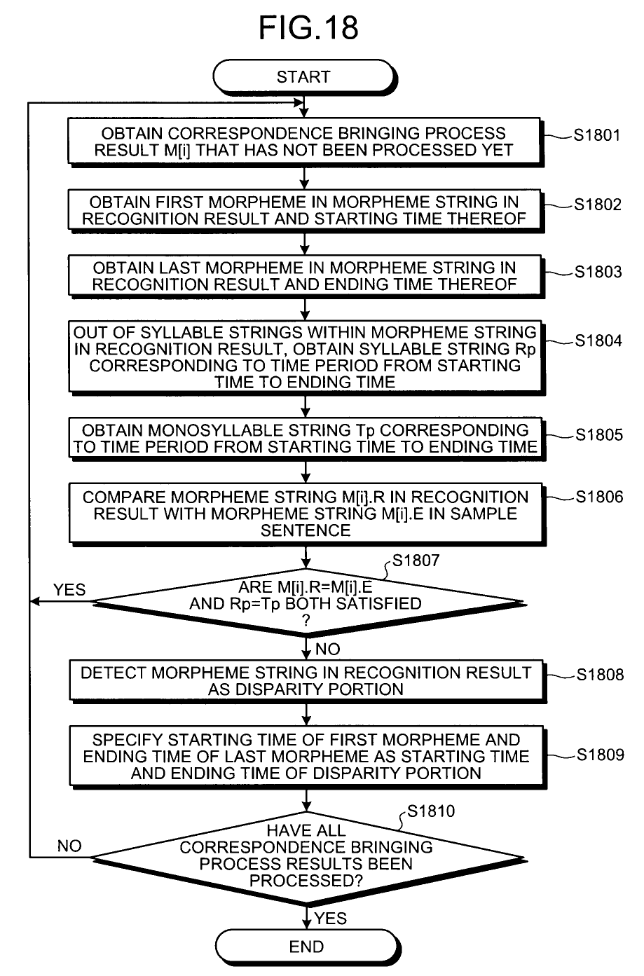

Next, the details of the disparity detecting process performed at step S1708 will be explained, with reference to FIG. 18.

First, the disparity detecting unit 1505 obtains a result M[i] (where 1≦i≦N) of the correspondence bringing process that has not been processed yet, out of the results of the correspondence bringing processes that have been combined (step S1801). After that, the disparity detecting unit 1505 obtains the first morpheme in the morpheme string in the result of the recognition process and the starting time of the first morpheme (step S1802). Also, the disparity detecting unit 1505 obtains the last morpheme in the morpheme string in the result of the recognition process and the ending time of the last morpheme (step S1803).

Subsequently, the disparity detecting unit 1505 obtains a syllable string Rp that is a series of syllables corresponding to the period of time from the obtained starting time to the obtained ending time, out of the syllables contained in the morpheme string in the result of the recognition process (step S1804). Further, the disparity detecting unit 1505 obtains a monosyllable string Tp corresponding to the period of time from the obtained starting time to the obtained ending time, out of the monosyllable string in the result of the recognition process (step S1805).

The morpheme string comparing process performed at step S1806 is the same as the process at step S1202 performed by the speech recognition apparatus 900 according to the second embodiment. Thus, the explanation thereof will be omitted.

After that, in addition to the process to judge whether M[i].R=M[i].E is satisfied, i.e., whether they match, the disparity detecting unit 1505 also compares the syllable string Rp that has been obtained at step S1804 with the monosyllable string Tp that has been obtained at step S1805 (step S1807).

In the case where both M[i].R=M[i].E and Rp=Tp are satisfied (step S1807: Yes), the disparity detecting unit 1505 does not detect M[i].R as a disparity portion. In any other cases (step S1807: No), the disparity detecting unit 1505 detects M[i].R as a disparity portion (step S1808).

The time setting process and the completion judging process performed at steps S1809 through S1810 are the same as the processes at steps S1205 through S1206 performed by the speech recognition apparatus 900 according to the second embodiment. Thus, the explanation thereof will be omitted.

Next, a specific example of the speech recognition process according to the third embodiment will be explained. In the following sections, an example in which input speech in Japanese “Takushii ni pasupooto o wasure chatta nodesu” meaning “I left my passport in a taxi” has been input will be explained.

The contiguous word recognizing unit 102 recognizes the input speech and generates a morpheme string as a result of the recognition process (step S1702). In the present example, it is assumed that a morpheme string as shown in FIG. 4 has been generated. It is also assumed that, as a sample sentence that is similar to the morpheme string shown in FIG. 4, the sentence obtaining unit 903 has obtained a sample sentence as shown in FIG. 10, out of the sample sentence storage unit 923 (step S1703).

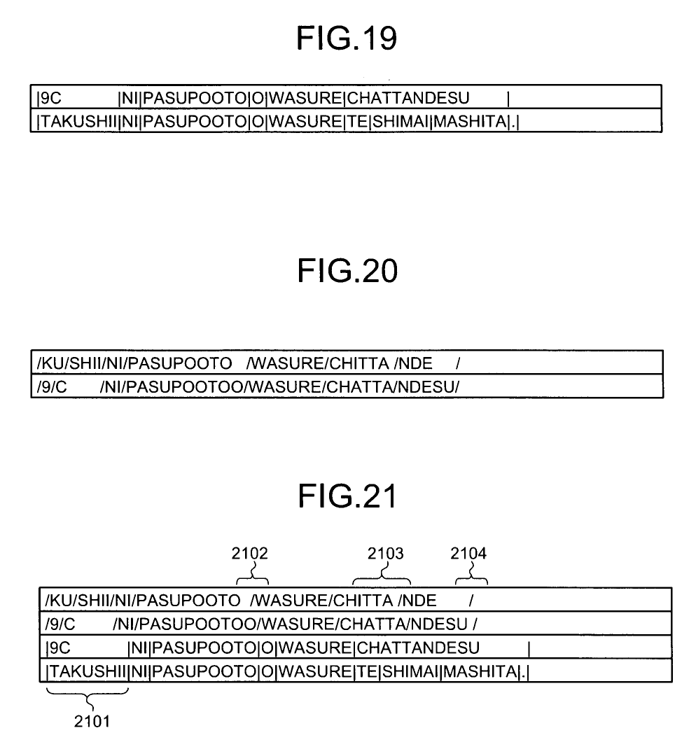

When the result of the recognition process as shown in FIG. 4 and the sample sentence as shown in FIG. 10 have been obtained, the sentence correspondence bringing unit 104 brings the morphemes into correspondence with one another by determining the degree of matching between the two morpheme strings (step S1704). FIG. 19 is a diagram illustrating an example of the morphemes that have been brought into correspondence with one another by the sentence correspondence bringing unit 104. The morpheme string in the result of the recognition process as shown in FIG. 4 is shown at the top of FIG. 19, whereas the sample sentence as shown in FIG. 10 is shown at the bottom of FIG. 19.

Further, according to the third embodiment, the monosyllable recognizing unit 1508 recognizes the input speech and generates a monosyllable string as a result of the recognition process (step S1705). In the present example, it is assumed that the monosyllable recognizing unit 1508 has generated a morpheme string as shown in FIG. 16.

When the monosyllable string as shown in FIG. 16 and the morpheme string as shown in FIG. 4 have been obtained as the results of the recognition processes, the syllable correspondence bringing unit 1509 brings the monosyllable string and the morpheme string into correspondence with each other by referring to the time information (step S1706). FIG. 20 is a diagram illustrating an example of the result of the correspondence bringing process performed by the syllable correspondence bringing unit 1509. The monosyllable string as shown in FIG. 16 is shown at the top of FIG. 20, whereas the morpheme string as shown in FIG. 4 is shown at the bottom of FIG. 20.

After that, by using the morpheme strings as references, the combining unit 1510 combines the results of the correspondence bringing processes in FIGS. 19 and 20 together (step S1707). In FIG. 21, the result of the correspondence bringing process in FIG. 20 shown at the top of FIG. 21 is combined with the result of the correspondence bringing process in FIG. 19 shown at the bottom of FIG. 21.

With any portion in which there is no syllable or morpheme that should be brought into correspondence, the sentence correspondence bringing unit 104, the syllable correspondence bringing unit 1509, and the combining unit 1510 bring an empty syllable or an empty morpheme into correspondence.

The disparity detecting unit 1505 compares the morphemes and the syllables that have been brought into correspondence with one another as shown in FIG. 21 and detects one or more disparity portions (step S1708). In the example shown in FIG. 21, the disparity detecting unit 1505 is able to detect a disparity portion 2101 at the beginning of the utterance, like in the example in the second embodiment.

Further, the disparity detecting unit 1505 according to the third embodiment is able to detect disparity portions 2102, 2103, and 2104 by comparing the morphemes and the syllables in units of syllables. More specifically, by comparing the result of the recognition process performed in units of monosyllables with the result of recognition process performed in units of morphemes, the disparity detecting unit 1505 is able to detect not only the disparity portion 2101 that has been found between the morpheme string in the result of the recognition process and the sample sentence, but also the disparity portions 2102 to 2104, which are in more detail.

For example, although the particle “∘” is contained in the morpheme string in the result of the recognition process, the corresponding monosyllable is not contained in the monosyllable string. Thus, the disparity detecting unit 1505 detects the disparity portion 2102. Also, the syllable “cha” that has been recognized in the morpheme string does not match the syllable “chi” that has been recognized in units of monosyllables. Thus, the disparity detecting unit 1505 detects the disparity portion 2103. Similarly, the syllables “ndesu” that have been recognized in the morpheme string does not match the syllable “nde” that has been recognized in units of monosyllables. Thus, the disparity detecting unit 1505 detects the disparity portion 2104.

After that, the cause information obtaining unit 106 analyzes the utterance position of each of the disparity portions within the input speech and the contents of the disparity. The cause information obtaining unit 106 then searches the cause information storage unit 124 for a piece of cause information that corresponds to the conditions satisfied by the analyzed utterance position and the contents of each of the disparities (step S1709).

In the example shown in FIG. 21, first, as the cause information corresponding to the disparity portion 2101, the cause information obtaining unit 106 obtains the piece of cause information identified with the number 1001 in FIG. 3. Also, with regard to the disparity portion 2102, because the particle “∘” contained in the morpheme in the middle of the utterance was not recognized, the cause information obtaining unit 106 obtains the piece of cause information identified with the number 1008 in FIG. 3. Further, with regard to the disparity portion 2103, because the consonant contained in the morpheme in the middle of the utterance was missing, the cause information obtaining unit 106 obtains the piece of cause information identified with the number 1007 in FIG. 3. In addition, with regard to the disparity portion 2104, because only the front part of the reading at the end of the utterance matched the corresponding morpheme, the cause information obtaining unit 106 obtains the piece of cause information identified with the number 1009 in FIG. 3.

As a result, the cause information obtaining unit 106 has obtained the pieces of advice identified with the numbers 1001, 1008, 1007, and 1009, for the disparity portions 2101 to 2104, respectively. After that, the output unit 107 outputs the obtained pieces of advice to the display device 132 (step S1107).

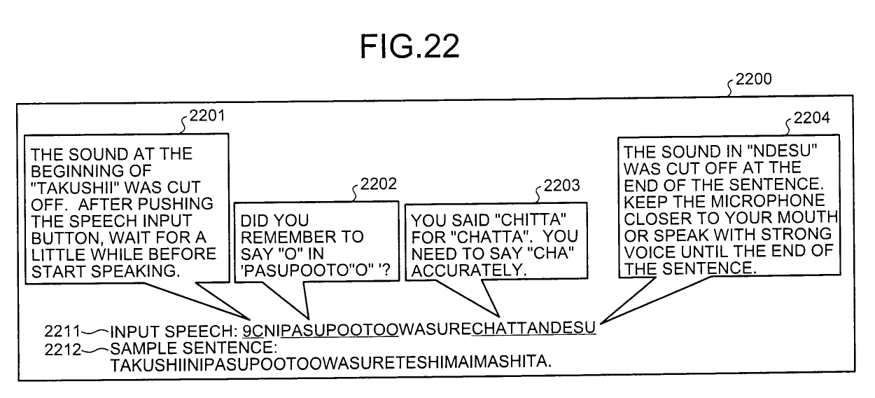

As shown in FIG. 22, on a display screen 2200, a input speech 2211 and a sample sentence 2212 that has been found in the search are displayed. In addition, the pieces of advice 2201 to 2204 that have been obtained for the disparity portions 2101 to 2104 are also displayed.

As explained above, the speech recognition apparatus according to the third embodiment recognizes the input speech not only in units of morphemes, but also in units of syllables. Thus, by comparing the result of the recognition process performed in units of syllables with the result of the recognition process performed in units of morphemes, the speech recognition apparatus is able to detect the disparity portions with a higher level of precision.

A speech recognition apparatus according to a fourth embodiment of the present invention is able to further detect acoustic information including the volume of input speech and to identify the causes of erroneous recognition further in detail by referring to the detected acoustic information.

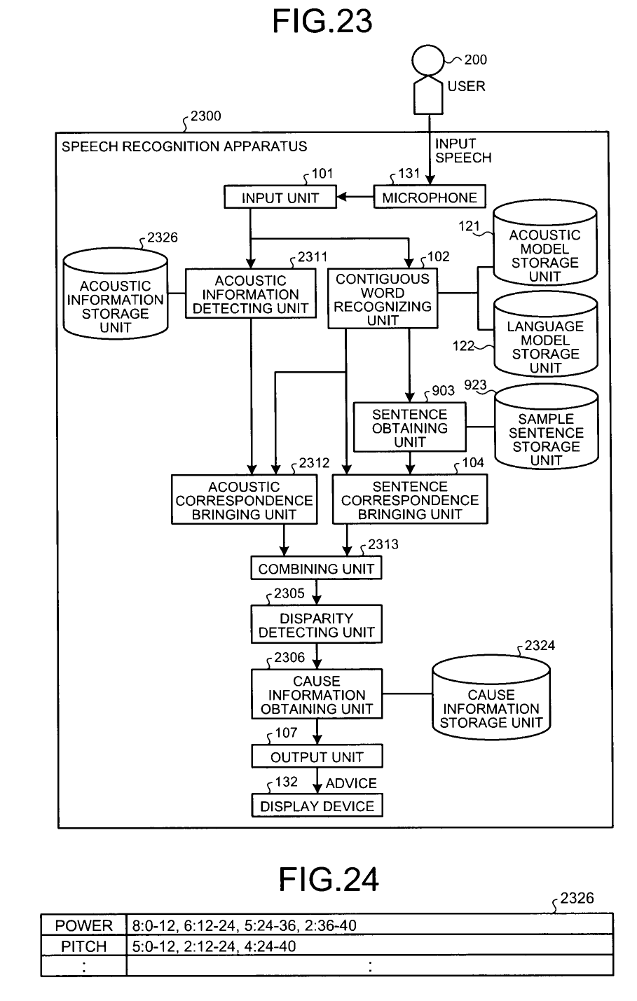

As shown in FIG. 23, a speech recognition apparatus 2300 includes, as the principal hardware configuration thereof, the microphone 131, the display device 132, the acoustic model storage unit 121, the language model storage unit 122, the sample sentence storage unit 923, a cause information storage unit 2324, and an acoustic information storage unit 2326. Also, the speech recognition apparatus 2300 includes, as the principal software configuration thereof, the input unit 101, the contiguous word recognizing unit 102, the sentence obtaining unit 903, the sentence correspondence bringing unit 104, a disparity detecting unit 2305, a cause information obtaining unit 2306, the output unit 107, an acoustic information detecting unit 2311, an acoustic correspondence bringing unit 2312, and a combining unit 2313.

The fourth embodiment is different from the second embodiment in that the acoustic information detecting unit 2311, the acoustic correspondence bringing unit 2312, the acoustic information storage unit 2326, and the combining unit 2313 are additionally provided, that the cause information storage unit 2324 has a data structure that is different from that of the second embodiment, and that the disparity detecting unit 2305 and the cause information obtaining unit 2306 have functions that are different from those of the second embodiment. The other configurations and functions are the same as those shown in FIG. 9, which is a block diagram of the speech recognition apparatus 900 according to the second embodiment. Thus, the same configurations and functions will be referred to by using the same reference characters, and the explanation thereof will be omitted.

The acoustic information detecting unit 2311 detects acoustic information of the input speech. For example, the acoustic information detecting unit 2311 detects acoustic information such as the power (i.e., the sound volume), the length of a pause (i.e., the length of a section having no sound), the pitch (i.e., the speed of the speech), and the intonation of the input speech. The acoustic information detecting unit 2311 outputs, for each of different types of acoustic information, a set made up of a value of a detected piece of acoustic information and time information (i.e., a starting time and an ending time) indicating the section in which the piece of acoustic information was detected and being expressed while the beginning of the input speech is used as a point of reference.

The acoustic information storage unit 2326 stores therein the acoustic information that has been detected by the acoustic information detecting unit 2311. As shown in FIG. 24, the acoustic information storage unit 2326 stores therein pieces of acoustic information that are categorized according to the type of acoustic information and that are expressed by using the format of “(the value of the piece of acoustic information):(time information)”. In the example shown in FIG. 24, the power is expressed by using a numerical value from 0 (low) to 10 (high), whereas the pitch is expressed by using a numerical value from 1 (fast) to 10 (slow).

Although omitted from the drawings, in the case where a section having no sound has been detected as part of the acoustic information, the time information (i.e., the starting time and the ending time) of the section having no sound is stored into the acoustic information storage unit 2326. As another example, in the case where the intonation has been detected as part of the acoustic information, a set made up of information indicating which one of rising intonation and falling intonation was used and the time information is stored into the acoustic information storage unit 2326.

The acoustic correspondence bringing unit 2312 brings each of the pieces of acoustic information that have been detected by the acoustic information detecting unit 2311 into correspondence with the morpheme string obtained as a result of the recognition process performed by the contiguous word recognizing unit 102. More specifically, by referring to the starting time and the ending time of each of the sections in which the pieces of acoustic information have been detected and the starting time and the ending time of each of the morphemes, the acoustic correspondence bringing unit 2312 brings the pieces of acoustic information and the morpheme string whose times match into correspondence with one another.

The combining unit 2313 combines the result of the correspondence bringing process performed by the sentence correspondence bringing unit 104 and the result of the correspondence bringing process performed by the acoustic correspondence bringing unit 2312 so that the pieces of acoustic information, the morpheme string obtained as a result of the recognition process, and the morpheme string in the sample sentence are brought into correspondence with one another.

The cause information storage unit 2324 is different from the cause information storage unit 124 explained in the exemplary embodiments above in that the cause information storage unit 2324 stores therein pieces of cause information further including the acoustic information and priority information. In this situation, the priority information is information showing whether a piece of advice obtained based on a piece of acoustic information should be obtained with a higher priority than a piece of advice obtained based on a morpheme.

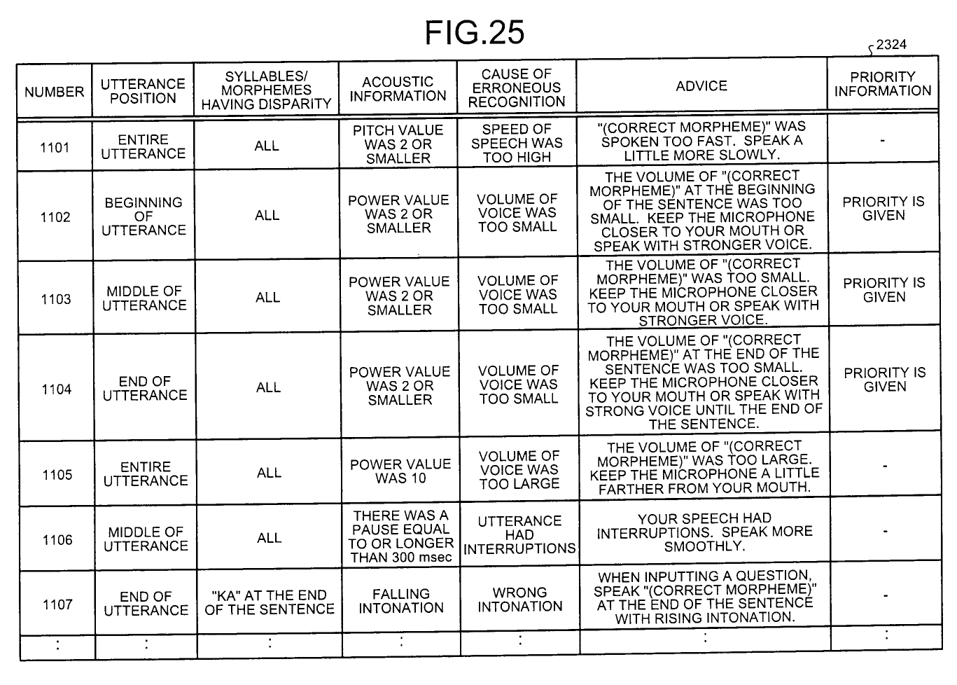

As shown in FIG. 25, the cause information storage unit 2324 stores therein pieces of cause information in each of which a number that identifies the piece of cause information, an utterance position, syllables/morphemes having a disparity, a piece of acoustic information, the cause of erroneous recognition, a piece of advice, and a piece of priority information are kept in correspondence with one another.

In the example shown in FIG. 25, only the pieces of cause information in each of which a piece of acoustic information is specified are shown. However, another arrangement is acceptable in which the cause information storage unit 2324 stores therein cause information in which the conditions of the syllables/morphemes having a disparity are specified, like the cause information shown in FIG. 3 according to the exemplary embodiments described above.

The disparity detecting unit 2305 is different from the disparity detecting unit 905 according to the second embodiment in that the disparity detecting unit 2305 outputs the detected disparity portions while further bringing the disparity portions and the pieces of acoustic information whose time information match, into correspondence with one another.

The cause information obtaining unit 2306 is different from the cause information obtaining unit 106 according to the second embodiment in that the cause information obtaining unit 2306 searches for a piece of cause information that satisfies the condition related to the acoustic information, in addition to the conditions related to the utterance position and the syllables/morphemes having a disparity, and that the cause information obtaining unit 2306 obtains a piece of cause information to which a higher priority is given by referring to the priority information.

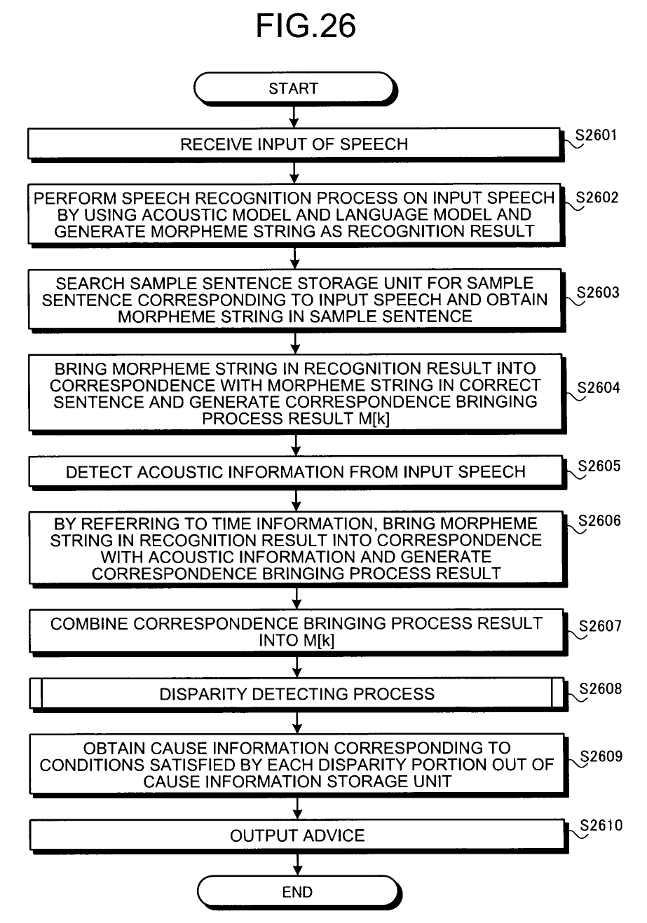

Next, the speech recognition process performed by the speech recognition apparatus 2300 according to the fourth embodiment configured as described above will be explained, with reference to FIG. 26.

The processes at steps S2601 through S2604 are the same as the processes at steps S1101 through step S1104 performed by the speech recognition apparatus 900 according to the second embodiment. Thus, the explanation thereof will be omitted.

After that, the acoustic information detecting unit 2311 detects one or more pieces of acoustic information from the input speech (step S2605). Subsequently, by referring to the time information, the acoustic correspondence bringing unit 2312 brings the morpheme string in the result of the recognition process into correspondence with the detected pieces of acoustic information and generates a result of the correspondence bringing process (step S2606).

After that, the combining unit 2313 combines the result of the correspondence bringing process performed by the acoustic correspondence bringing unit 2312 into the results M[k] obtained as a result of the correspondence bringing process performed by the sentence correspondence bringing unit 104 (step S2607). Because each of the results of the correspondence bringing processes contains the morpheme string in the result of the recognition process, the combining unit 2313 is able to combine the two results of the corresponding bringing processes by using the morpheme strings as references.

The order in which the processes at steps S2603 through S2604 and the processes at steps S2605 through 2606 are performed is not limited to the example described above. It is acceptable to perform the processes at steps S2605 through S2606 first. Another arrangement is acceptable in which the processes at steps S2603 through S2604 and the processes at steps S2605 through 2606 are performed in parallel. In other words, it is acceptable to perform these processes in any order as long as the results of the correspondence bringing processes have been generated by the time when a combining unit 2310 is to combine these results of the correspondence bringing processes together.

The disparity detecting process performed at step S2608 is the same as the process at step S1105 performed by the speech recognition apparatus 900 according to the second embodiment. Thus, the explanation thereof will be omitted.

After that, the cause information obtaining unit 2306 obtains one of the pieces of cause information that corresponds to the conditions satisfied by each of the detected disparity portions, out of the cause information storage unit 124 (step S2609). By using the piece of acoustic information that has been brought into correspondence with each of the detected disparity portions, the cause information obtaining unit 2306 according to the fourth embodiment searches for the piece of cause information while taking the condition related to the acoustic information into consideration.

Subsequently, the output unit 107 outputs the piece of advice contained in the obtained piece of cause information to the display device 132 (step S2610), and the speech recognition process ends.

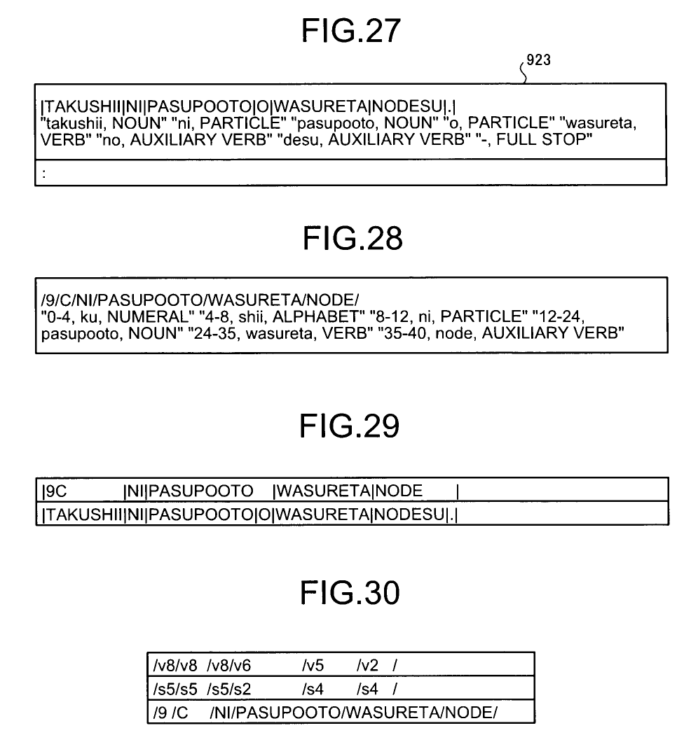

Next, a specific example of the speech recognition process according to the fourth embodiment will be explained. In the following sections, it is assumed that the sample sentence storage unit 923 stores therein sample sentences including the one shown in FIG. 27. In other words, the sample sentence storage unit 923 stores therein the sample sentence in Japanese “Takushii ni pasupooto o wasureta nodesu” meaning “I left my passport in a taxi”. It is also assumed that the user utters the same sample sentence and inputs the speech in Japanese to the speech recognition apparatus 2300.

The contiguous word recognizing unit 102 recognizes the input speech and generates a morpheme string as a result of the recognition process (step S2602). In the present example, it is assumed that the contiguous word recognizing unit 102 has generated a morpheme string as shown in FIG. 28. It is also assumed that, as a sample sentence that is similar to the morpheme string shown in FIG. 28, the sentence obtaining unit 903 has obtained a sample sentence as shown in FIG. 27, out of the sample sentence storage unit 923 (step S2603).

When the result of the recognition process as shown in FIG. 28 and the sample sentence as shown in FIG. 27 have been obtained, the sentence correspondence bringing unit 104 brings the morphemes into correspondence with one another by determining the degree of matching between the two morpheme strings (step S2604). FIG. 29 is a diagram illustrating an example of the morphemes that have been brought into correspondence by the sentence correspondence bringing unit 104. The morpheme string in the result of the recognition process as shown in FIG. 28 is shown at the top of FIG. 29, whereas the sample sentence as shown in FIG. 27 is shown at the bottom of FIG. 29.

According to the fourth embodiment, the acoustic information detecting unit 2311 further detects acoustic information from the input speech (step S2605). In the present example, it is assumed that the acoustic information detecting unit 2311 has detected pieces of acoustic information as shown in FIG. 24 (regarding the power and the pitch).

When the pieces of acoustic information as shown in FIG. 24 and the morpheme string as shown in FIG. 28 have been obtained, the acoustic correspondence bringing unit 2312 brings the pieces of acoustic information and the morpheme string into correspondence with each other, by referring to the time information (step S2606). FIG. 30 is a diagram illustrating an example of a result of the correspondence bringing process performed by the acoustic correspondence bringing unit 2312.

The acoustic information as shown in FIG. 24 is shown at the top of FIG. 30, whereas the morpheme string as shown in FIG. 28 is shown at the bottom of FIG. 30. Also, in FIG. 30, the power is expressed by using the format of “v (the value of the power)”, whereas the pitch is expressed by using the format of “s (the value of the pitch)”.

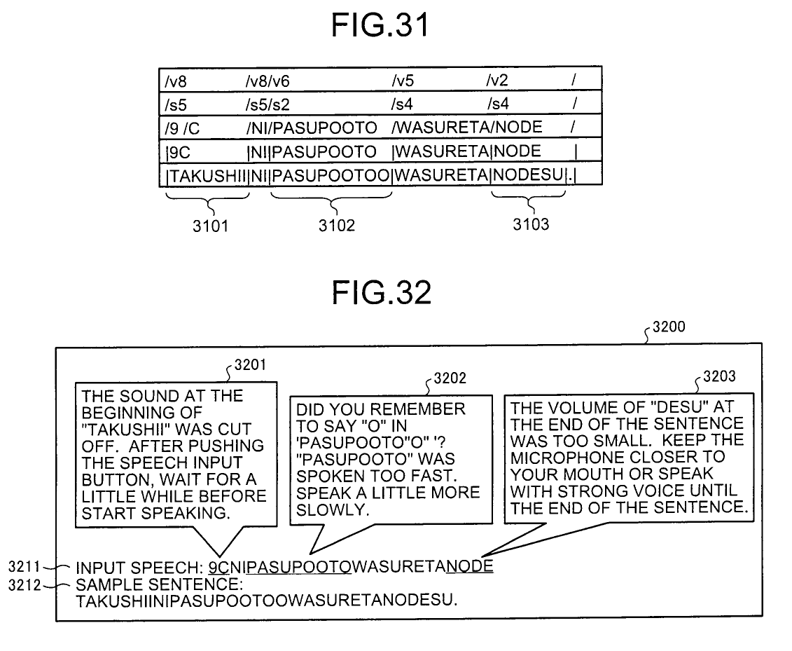

After that, the combining unit 2313 combines the results of the correspondence bringing processes shown in FIGS. 29 and 30 together, by using the morpheme strings as references (step S2607). FIG. 31 is a diagram illustrating an example in which the results of the correspondence bringing processes have been combined by the combining unit 2313. The result of the correspondence bringing process as shown in FIG. 30 is shown at the top of FIG. 31, whereas the result of the correspondence bringing process as shown in FIG. 29 is shown at the bottom of FIG. 31.

The disparity detecting unit 2305 compares the morphemes that have been brought into correspondence as shown in FIG. 31 and detects one or more disparity portions (step S2608). In the example shown in FIG. 31, the disparity detecting unit 2305 is able to detect a disparity portion 3101 at the beginning of the utterance, a disparity portion 3102 in the middle of the utterance, and a disparity portion 3103 at the end of the utterance.

Subsequently, the cause information obtaining unit 2306 analyzes the piece of acoustic information that has been brought into correspondence with each of the disparity portions, in addition to the utterance position of each of the disparity portions within the input speech and the contents of the disparity. The cause information obtaining unit 2306 then searches the cause information storage unit 2324 for a piece of cause information that corresponds to the conditions satisfied by the utterance position, the contents of the disparity, and the piece of acoustic information (step S2609).

In the example shown in FIG. 31, first, the cause information obtaining unit 2306 obtains the piece of cause information identified with the number 1001 in FIG. 3 as the cause information for the disparity portion 3101. On the other hand, the cause information storage unit 2324 shown in FIG. 25 stores therein no cause information that contains the condition related to the acoustic information satisfied by the power value 8 and the pitch value 5 that have been brought into correspondence with the disparity portion 3101. Thus, the cause information obtaining unit 2306 obtains the piece of advice identified with the number 1001 for the disparity portion 3101.

Also, for the disparity portion 3102, because the particle “∘” in the morpheme in the middle of the utterance was not recognized, the cause information obtaining unit 2306 obtains the piece of cause information identified with the number 1008 in FIG. 3. The cause information storage unit 2324 shown in FIG. 25 stores therein the piece of cause information that is identified with a number 1101 and contains the condition related to the acoustic information satisfied by the power value 6 and the pitch value 2 that have been brought into correspondence with the disparity portion 3102. Also, this piece of cause information is not specified by the priority information as one of the pieces of cause information to which “PRIORITY IS GIVEN”. Thus, the cause information obtaining unit 2306 obtains both pieces of advice identified with the numbers 1008 and 1101.

Further, for the disparity portion 3103, because only the front part of the reading at the end of the utterance matched the corresponding morpheme, the cause information obtaining unit 2306 obtains the piece of cause information identified with the number 1009 in FIG. 3. The cause information storage unit 2324 shown in FIG. 25 stores therein the piece of cause information that is identified with a number 1104 and contains the condition related to the acoustic information satisfied by the power value 2 and the pitch value 4 that have been brought into correspondence with the disparity portion 3103. Also, this piece of cause information is specified by the priority information as one of the pieces of cause information to which “priority is given”. Thus, the cause information obtaining unit 2306 does not obtain the piece of advice identified with the number 1009, but obtains only the piece of advice identified with the number 1104.

After that, the output unit 107 outputs the obtained pieces of advice to the display device 132 (step S2610).

As shown in FIG. 32, on a display screen 3200, a input speech 3211 and the sample sentence 3212 found in the search are displayed. In addition, the pieces of advice 3201, 3202, and 3203 that have been obtained for the disparity portions 3101, 3102, 3103 are also displayed.

As explained above, the speech recognition apparatus according to the fourth embodiment is able to identify the causes of erroneous recognition further in detail, by referring to the acoustic information that is related to, for example, the sound volume of the input speech.

In the third and the fourth embodiments, it is acceptable to use the correct sentence storage unit as described in the first embodiment, instead of the sample sentence storage unit. Also, it is acceptable to combine the third embodiment and the fourth embodiment together, so that it is possible to use both the function to detect the disparity portions with a high level of precision by performing the recognition process in units of monosyllables and the function to identify the causes of the disparities in detail by detecting the acoustic information.

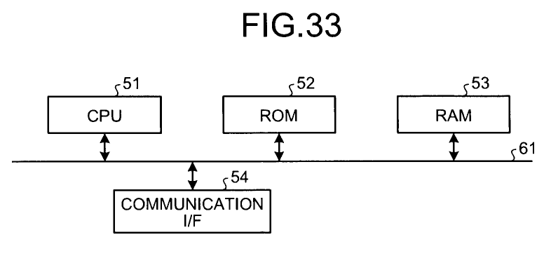

Next, a hardware configuration of the speech recognition apparatuses according to the first to the fourth embodiments will be explained, with reference to FIG. 33.

Each of the speech recognition apparatuses according to the first to the fourth embodiments includes a controlling device like a Central Processing Unit (CPU) 51, storage devices like a Read-Only Memory (ROM) 52 and a Random Access Memory (RAM) 53, as well as a communication interface (I/F) 54 that establishes a connection to a network and performs communication and a bus 61 that connects these constituent elements to one another.

A speech recognition computer program executed by each of the speech recognition apparatuses according to the first to the fourth embodiments is provided as being incorporated in advance in the ROM 52 or the like.

Another arrangement is acceptable in which the speech recognition computer program executed by each of the speech recognition apparatuses according to the first to the fourth embodiments is provided as being recorded on a computer-readable recording medium such as a Compact Disk Read-Only Memory (CD-ROM), a Flexible Disk (FD), a Compact Disk Recordable (CD-R), a Digital Versatile Disk (DVD), or the like, in a file that is in an installable format or in an executable format.

Further, yet another arrangement is acceptable in which the speech recognition computer program executed by each of the speech recognition apparatuses according to the first to the fourth embodiments is stored in a computer connected to a network like the Internet and provided as being downloaded via the network. Yet another arrangement is acceptable in which the speech recognition computer program executed by each of the speech recognition apparatuses according to the first to the fourth embodiments is provided or distributed via a network like the Internet.

The speech recognition computer program executed by each of the speech recognition apparatuses according to the first to the fourth embodiments has a module configuration that includes the functional units described above (e.g., the input unit, the contiguous word recognizing unit, the sentence obtaining unit, the sentence correspondence bringing unit, the disparity detecting unit, the cause information obtaining unit, and the output unit). As the actual hardware configuration, these functional units are loaded into a main storage device when the CPU 51 reads and executes the speech recognition computer program from the ROM 52, so that these functional units are generated in the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech recognition apparatus comprising:
an exemplary sentence storage unit that stores exemplary sentences;
an information storage unit that stores conditions and pieces of output information that are brought into correspondence with one another, each of the conditions being defined in advance based on a disparity portion and contents of a disparity between inputs of speech and any of the exemplary sentences, and each of the pieces of output information being related to a cause of the corresponding disparity;
an input unit that receives an input of speech;
a first recognizing unit that recognizes the input speech as a morpheme string, based on an acoustic model defining acoustic characteristics of phonemes and a language model defining connection relationships among morphemes;
a sentence obtaining unit that obtains one of the exemplary sentences related to the input speech from the exemplary sentence storage unit;
a sentence correspondence bringing unit that brings each of first morphemes into correspondence with at least one of second morphemes, based on a degree of matching to which each of the first morphemes contained in the recognized morpheme string matches any of the second morphemes contained in the obtained exemplary sentence;
a disparity detecting unit that detects one or more of the first morphemes each of which does not match the corresponding one of the second morphemes, as the disparity portions;
an information obtaining unit that obtains one of the pieces of output information corresponding to the condition of each of the detected disparity portions, from the information storage unit; and
an output unit that outputs the obtained pieces of output information.

2. The apparatus according to claim 1, further comprising:
a second recognizing unit that recognizes the input speech as a monosyllable string, based on the acoustic model and dictionary information defining vocabulary corresponding to monosyllables; and
a syllable correspondence bringing unit that brings each of monosyllables contained in the recognized monosyllable string into correspondence with any of syllables contained in the first morphemes that has a matching utterance section within the input speech, wherein
the disparity detecting unit further detects one or more of the first morphemes in each of which the contained syllables do not match the corresponding ones of the monosyllables, as the disparity portions.

3. The apparatus according to claim 1, wherein the sentence obtaining unit obtains a specified one of the exemplary sentences from the exemplary sentence storage unit, as the one of the exemplary sentences related to the input speech.

4. The apparatus according to claim 1, wherein the sentence obtaining unit obtains the one of the exemplary sentences that is similar to the input speech or completely matches the input speech, from the exemplary sentence storage unit.

5. The apparatus according to claim 4, wherein the disparity detecting unit calculates a number of characters in each of the first morphemes do not match characters in the corresponding one of the second morphemes, calculates a ratio of the number of characters to a total number of characters in each of the first morphemes, and detects one or more of the first morphemes in each of which the ratio is smaller than a predetermined threshold value, as the disparity portions.

6. The apparatus according to claim 1, further comprising:
an acoustic information detecting unit that detects pieces of acoustic information each showing an acoustic characteristic of the input speech, and outputs pieces of section information and the detected pieces of acoustic information that are brought into correspondence with one another, the pieces of section information each showing one of speech sections within the input speech from which the corresponding piece of acoustic information is detected; and
an acoustic correspondence bringing unit that brings each of the detected pieces of acoustic information into correspondence with any of the syllables contained in the first morphemes whose speech section within the input speech matches the speech section shown in the piece of section information corresponding to the piece of acoustic information, wherein
the information storage unit stores the conditions each of which is related to one of the pieces of acoustic information in one of the disparity portions and the pieces of output information that are brought into correspondence with one another, and
the information obtaining unit obtains, from the information storage unit, the one of the pieces of output information corresponding to the condition of the piece of acoustic information brought into correspondence with each of the detected disparity portions.

7. The apparatus according to claim 6, wherein each of the pieces of acoustic information is at least one of a sound volume, a pitch, a length of a section having no sound, and an intonation.

8. The apparatus according to claim 1, wherein
the information storage unit stores position conditions, vocabulary conditions, and the pieces of output information that are brought into correspondence with one another, the position conditions each being related to an utterance position of each of the disparity portions within the input speech, and the vocabulary conditions each being related to vocabulary that does not match between any of the second morphemes brought into correspondence with each of the disparity portions and the disparity portion, and
the information obtaining unit extracts an utterance position of each of the detected disparity portions within the input speech and the vocabulary that does not match between each of the detected disparity portions and any of the second morphemes brought into correspondence with the disparity portion, and obtains, from the information storage unit, the one of the pieces of output information corresponding to one of the position conditions satisfied by the extracted utterance position and one of the vocabulary conditions satisfied by the extracted vocabulary.

9. A speech recognition method comprising:
receiving an input of speech;
recognizing the input speech as a morpheme string, based on an acoustic model defining acoustic characteristics of phonemes and a language model defining connection relationships among morphemes;
obtaining, from an exemplary sentence storage unit storing exemplary sentences, one of the exemplary sentences that is related to the input speech;
bringing, based on a degree of matching to which each of first morphemes contained in the recognized morpheme string matches any of second morphemes contained in the obtained exemplary sentence, each of the first morphemes into correspondence with at least one of the second morphemes;
detecting one or more of the first morphemes each of which does not match the corresponding one of the second morphemes as disparity portions;
obtaining, from an information storage unit storing conditions each being defined in advance based on a disparity portion and contents of a disparity and pieces of output information each being related to a cause of a disparity while bringing the conditions and the pieces of output information into correspondence with one another, one of the pieces of output information corresponding to the condition of each of the detected disparity portions; and
outputting the obtained pieces of output information.

10. A computer program product having a computer readable medium including programmed instructions for recognizing speech, wherein the instructions, when executed by a computer, cause the computer to perform:
receiving an input of speech;
recognizing the input speech as a morpheme string, based on an acoustic model defining acoustic characteristics of phonemes and a language model defining connection relationships among morphemes;
obtaining, from an exemplary sentence storage unit storing exemplary sentences, one of the exemplary sentences that is related to the input speech;
bringing, based on a degree of matching to which each of first morphemes contained in the recognized morpheme string matches any of second morphemes contained in the obtained exemplary sentence, each of the first morphemes into correspondence with at least one of the second morphemes;
detecting one or more of the first morphemes each of which does not match the corresponding one of the second morphemes as disparity portions;
obtaining, from an information storage unit storing conditions each being defined in advance based on a disparity portion and contents of a disparity and pieces of output information each being related to a cause of a disparity while bringing the conditions and the pieces of output information into correspondence with one another, one of the pieces of output information corresponding to the condition of each of the detected disparity portions; and outputting the obtained pieces of output information.
